(19) United States
(12) Patent Application Publication
(10) Pub. No.: US 2009/0024505 A1
(43) Pub. Date: Jan. 22, 2009

(54) Global Risk Administration Method and System

(75) Inventors: Amit R. Patel, Woodbridge, NJ (US); Song Ting Ceng, Brooklyn, NY (US); Girish Narang, Mineola, NY (US); Jeremy Sokolic, New York, NY (US)

Correspondence Address: COURTNEY STANIFORD & GREGORY LLP, P.O. BOX 9686, SAN JOSE, CA, 95157, US

(73) Assignee: CashEdge, Inc., New York, NY (US)

(21) Appl. No.: 12/165,532

(22) Filed: Jun. 30, 2008

Related U.S. Application Data
(60) Provisional application No. 60/937,748, filed on Jun. 28, 2007.

(51) Int. Cl. G06Q 40/00

(52) U.S. Cl. 705/35

(57) ABSTRACT

Embodiments of a Global Risk Administration (GRA) method and system include a GRA tool that assists an institution with various decision making processes by enabling the institution to customize the GRA tool to generate decisions based on information input by the institution or a customer of the institution. The GRA tool further accesses third party data sources for the purpose of verifying information and gathering additional information to be used in generating decisions. The data sources are selectable by the institution as an aspect of the customization in an embodiment. In an embodiment, the institution is a financial institution (FI), and customizing the GRA tool involves an FI user assigning attribution rules using, wherein attribution rules comprise characteristics of applicants for financial accounts. The user further creates one or more decision classes using the UI, wherein one or more attribution rules place an applicant in a decision class; and the user creates business rules, wherein a business rule determines a manner in which the GRA module interprets data from the third party data sources.

### RELATED APPLICATIONS

This application claims the benefit of U.S. Provisional Patent Application No. 60/937,748 filed Jun. 28, 2007, which is hereby incorporated by reference in its entirety.

### BACKGROUND

Hundreds and possibly thousands of potential customers apply for financial products online each week. Financial institutions (also referred to herein as “FIs”) and other service providers are not able to evaluate each applicant manually to determine whether to approve or decline an application. Furthermore, because this is an online application, service providers cannot ascertain they are dealing with the actual customer, and not a fraudster. FIs may create separate software tools to assist in evaluating the risk of approving an application for a financial product or service and verify the applicant identity. However, this process is costly and cumbersome for the FI. For example, the FI would have to develop and maintain the tool. FIs might possibly have to separately negotiate or arrange access to multiple third party data sources in order to make a risk assessment.

### BRIEF DESCRIPTION OF THE DRAWINGS

FIG. 1 is a block diagram of a system including a financial management system (FMS) according to an embodiment.

FIG. 2 is a flow diagram illustrating a process of a user creating a decision class according to an embodiment.

FIG. 3 is a flow diagram illustrating selection of data sources and rules of a class according to an embodiment.

FIG. 4 is a flow diagram illustrating data source management according to an embodiment.

FIG. 5 is a user interface (UI) screen for adding a decision class.

FIG. 6 is a UI screen for deleting a decision class.

FIG. 7 is a UI screen for adding attribution rules.

FIG. 8 is a separate UI screen for the user to select the exact applicant profile value which s/he would like to create an attribution rule around.

FIG. 9 is a UI screen for editing the attribution rule.

FIG. 10 is a UI screen for deleting an attribution rule.

FIG. 11 is a UI screen for viewing the complete list of created attribution rules.

FIG. 12 is a UI screen showing sources and rules for selected decision classes. It also allows users to manage data sources.

FIG. 13 is a UI screen for adding eID verifier rules

FIG. 14 is a UI screen for editing an eID verifier rule

FIG. 15 is a UI screen for deleting an eID verifier rule.

FIG. 16 is a UI screen for viewing the eID verifier rules that have been created.

FIG. 17 is a UI screen for adding eID compare rules.

FIG. 18 is a UI screen for editing the eID compare rules.

FIG. 19 is a UI screen for deleting an eID compare rule.

FIG. 20 is a UI screen for viewing all of the eID compare rules that have been created.

FIG. 21 is a UI screen for adding new ChexSystem Rules and for adding new Qualifile rules.

FIG. 22 is a UI screen to which the user is directed after clicking on a name in FIG. 21.

FIG. 23 is a UI screen editing a rule.

FIG. 24 is a UI screen for deleting a rule.

FIG. 25 is a UI screen to view all the rules associated with ChexSystems.

FIG. 26 is a UI screen for adding an applicant profile rule.

FIG. 27 is a UI screen for editing an applicant profile rule.

FIG. 28 is a UI screen for deleting an applicant profile rule.

FIG. 29 is a UI screen for viewing all of the applicant profile rules that have been created.

FIG. 30 is a UI screen for adding a final decision rule.

FIG. 31 is a UI screen for editing a final decision rule.

FIG. 32 is a UI screen for deleting a final decision rule.

FIG. 33 is a UI screen for viewing all final decision rules that have been created.

FIG. 34 is a UI screen for viewing an audit trail according to an embodiment.

### DETAILED DESCRIPTION

Embodiments of a Global Risk Administration (GRA) method and system include a GRA tool that assists an institution with various decision making processes by enabling the institution to customize the GRA tool to generate decisions based on information input by the institution or a customer of the institution. The GRA tool further accesses third party data sources for the purpose of verifying information and gathering additional information to be used in generating decisions. The data sources are selectable by the institution as an aspect of the customization in an embodiment.

For the purpose of providing examples for disclosing the claimed invention, the institutions referred to herein are financial institutions (FIs) and the decision making involves whether to approve customer applications for financial accounts, but embodiments are not so limited. Embodiments allow FIs to assess the amount of risk they would like to assume when accepting applications for financial products or services and verifying the customer's identity. In an embodiment, the GRA tool renders a decision in real time, informing the customer of the decision instantaneously.

According to various embodiments, FIs have enhanced flexibility in designing and applying business rules used to make an automated real-time decision. For example, customers can be subject to different business rules based on who they are, what products they are applying for, etc. For instance, an FI can have more relaxed standards for customers applying only for a savings account than for customers applying for a checking account.

Embodiments also allow FIs to choose among data sources based on FI criteria. As an example, an FI can choose to skip ChexSystem (one of the GRA data sources), when the customer is applying only for a savings account. Similarly, an FI can choose to skip eID Verifier, another GRA data source, when the applicant is an existing customer of the same FI.

Further regarding data sources, users also have the ability to control the execution of data sources, that is, in what order the data sources are consulted. FI may choose to stop using downstream data sources if the FI could make a decision based on the data received from already executed data sources. For example, FI plans to use six different data sources to make the automated real-time decision. However, FI knows that they will decline the application if eID Verifier, one of their six data sources, is not able to confirm the customer's identity. FI could choose to use eID Verifier first. GRA will use the other data sources only if eID Verifier confirms the customer's identity. Otherwise, based on the FI business rules, the tool will decline the customer after receiving unfavorable data from eID Verifier.

An FI may also choose to use an additional data sources if the response from the original data source is not satisfactory. For example, eID Compare, a GRA data source, might not be able to positively identify a customer. The FI can choose to use eID Compare at all times and then use eID Verifier when eID Compare is not able to make a positive identification. Embodiments described herein provide a GRA module that is fully customizable by the FI.

Embodiments also enable FIs to choose to use a backup data source if the original data source is out of commission. For example, eID Verifier and Verid are comparable data sources that use interactive questions to verify an applicant's identity. FI can choose to use eID Verifier as their main data source and elect to use Verid as a backup if eID Verifier is out of service.

Alternatively, an FI could choose to automatically retry a data source if the data source is out of commission while the applicant is applying. For example, ChexSystem is not responding while the customer is applying. FI could give the customer a review decision and let the customer know a decision will be made later. Instead of manually getting information from ChexSystem, FI could choose to let GRA automatically retry ChexSystem at a later time to render a decision. Furthermore, if the out of commission data source has Interactive Questions, the FI could give the customer a review decision and ask the customer to return at a later time. When the customer returns, GRA will automatically retry the data source. GRA will not retry data sources that already provided data.

FI could have the flexibility to use comparable data sources at the same time and analyze the effectiveness of each data source to refine their risk assumption rules. For example, FI could divide their customer into two groups, each group using a different data source which provides comparable services; for example, eID Verifier and Verid. After a period of time, FI would review the two groups and determine which data source is more effective at mitigating risk. The FI could choose the data source better at preventing fraud.

In various embodiments, the GRA tool is available as part of a suite of services provided to the FI by a financial management system (FMS). In other embodiments services are provided by a management system that is not related to financial services. The suite includes account opening services and funds transfer services. The FI is provided with access to this suite of coordinated services that are accessible though a user interface or an XML API interface. The suite of services is executed by software developed and maintained by the FMS. The FMS leverages relationships with multiple FIs and with multiple third party data sources efficiently to provide a broad array of services. In examples given herein for the purpose of disclosing the claimed invention, embodiments of a GRA tool are available as an accompaniment to account opening and funds transfer services offered by CashEdge, Inc.™ (referred to herein as “CashEdge”) as the FMS.

An example account opening process using the FMS account opening tools begins with the collection of applicant data through an FMS-provided online application form. An FI can also send the applicant data to the FMS. The applicant data, which includes personal information and responses to interactive questions (e.g. “What is the name of your mortgage lender?”), is then sent to outside data sources. These data sources evaluate each applicant, and provide the FMS with various information regarding the applicant, for example, identity verification data, address verification data, debit/credit history, etc.

Received information is then used to render an automated decision, which places the application into one of three categories of decisions: approve; decline; or review. For the applications in review status, the host FI (that is, the FI that the applicant is applying with) manually intervenes by collecting more data and/or conducting further review, and ultimately renders a final approve or decline decision. The mechanism to make the automated decision to approve, decline applications or put them into review is control by the GRA tool, is further described below. Each different FI uses the GRA tool (also referred to as a GRA module herein) to build decision rules for the various data sources based on each individual FI's tolerance for risk and fraud. In one embodiment, applicants submit an online application for banking products via CashEdge's™ OpenNow FundNow™ (ONFN) application. The FI (which uses ONFN as one of the services in the CashEdge™ suite uses the GRA module to aid in making the decision on the application. CashEdge™ is the FMS in this case. The following is an overview of a GRA module process according to an embodiment:
1. The FMS gathers all the relevant customer information via the online application, and sends the data to various online data sources, which provide the FMS with various information regarding the applicant, for example, identity verification data, address verification data, debit/credit history, etc.
2. Based on the type of data expected from the data sources, the FI creates Business Rules regarding how to interpret the data from each of the data sources, and creates final business rules regarding how to interpret the data across the data sources.
3. For every application that is submitted, the FMS takes all the data from all the data sources, runs all the data through the business rules and final decision rules created by the FI, and produces a decision to approve, decline, or manually review the application.

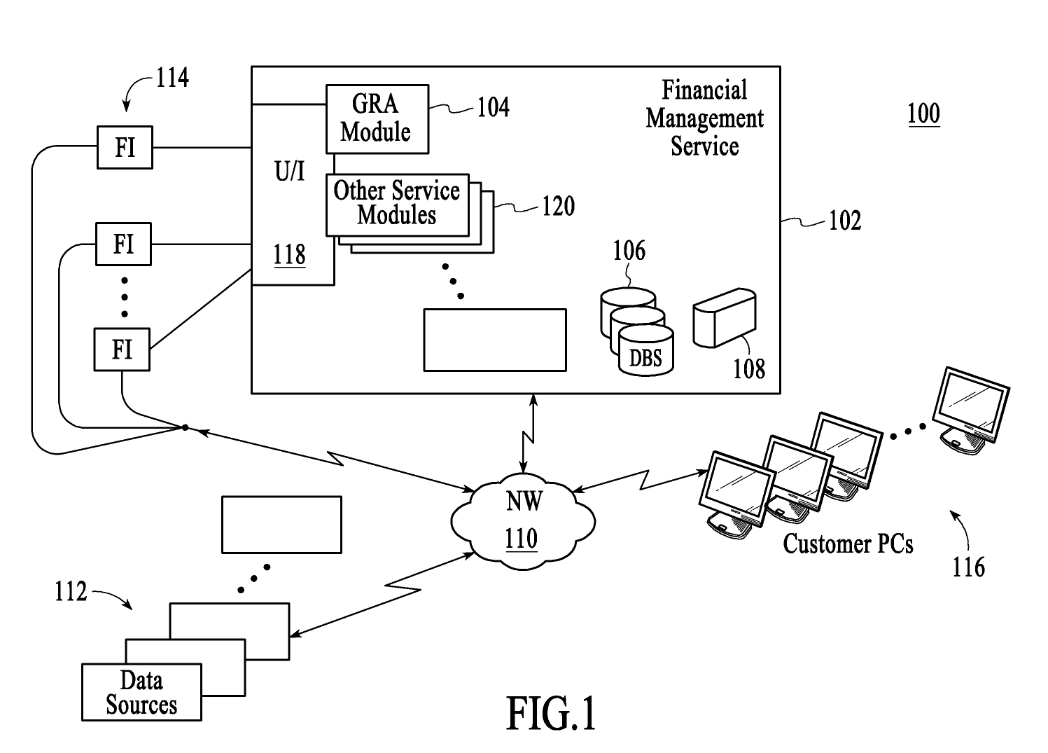

FIG. 1 is a block diagram of a system 100 including a financial management system (FMS) 102 according to an embodiment. FMS 102 includes one or more servers 108 and one or more databases 106. FMS 102 provides and facilitates multiple financial services, typically for or on behalf of financial institutions (FIs) 114. In addition, FMS 102 provides and facilitates financial services for customers, either directly or through one or more of FIs 114. Customers access financial services using customer personal computers (PCs) 116. Customer can also call into a call center provided by the FI, walk into a branch, or use a kiosk set up by the FI to access the financial services. Customers can be individuals or businesses. Customer PCs 116 can be individual PCs or business PCs or servers. FMS 102 communicates with FIs 114, customer PCs 116 and multiple data sources 112 through a network 110. Network 110 is typically the Internet, but could be any other wired or wireless network capable of electronic data communication.

FMS 102 includes a global rules administration module 104, as described in further detail below. Various other service modules 120 provide various financial services, including but not limited to account opening services, funds transfer services, invoicing services, bill payment services, etc. GRA module 104 and other service modules 120 further include a user interface (UI) 118. In various embodiments, a user can access GRA module 104 and some or all of other service modules 120 through a single UI 118, but embodiments are not so limited. For purposes of describing GRA module 104, a “user” herein refers to an employee of a FI 114 that is interacting with the UI module 118, for example to set up and customize the GRA module for a particular FI. However, other types of users are also contemplated.

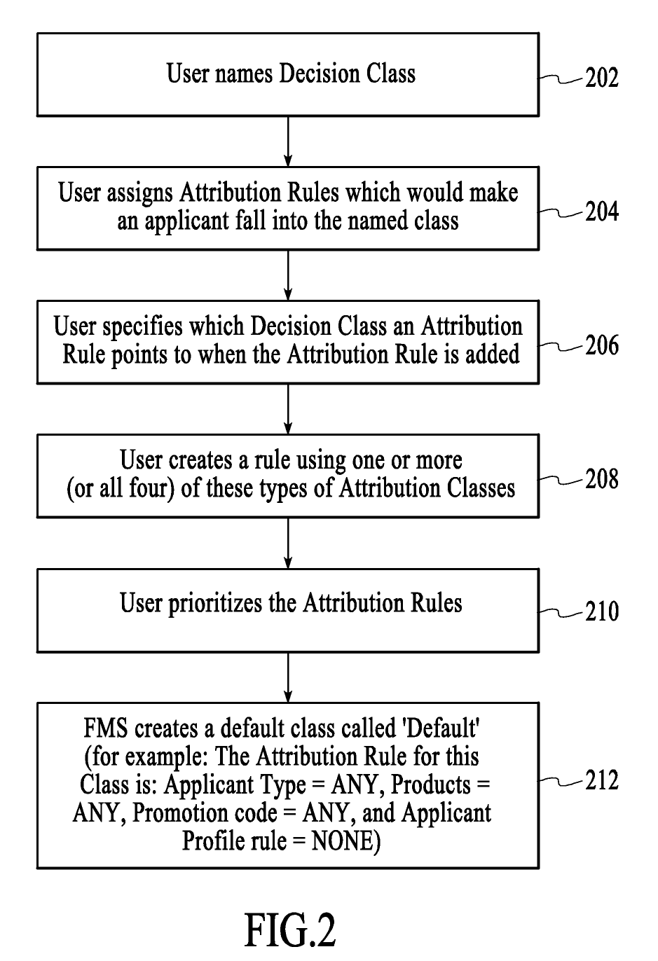

FIG. 2 is a flow diagram illustrating a process of a user creating a decision class according to an embodiment. As stated, the user may be an employee of an FI 114 who is customizing the GRA module 104 through the UI 118.

At 202, the user names a decision class. There are no limitations on names that can be assigned to decision classes. At 204, the user assigns attribution rules, or characteristics of an applicant, which would make an applicant fall into the particular named class. The user attribution rule is added. In an embodiment, multiple attribution rules could belong to the same class at 206. For example, Attribution Rule #3 can state that a primary applicant applying for ABC Savings who lives in NJ could belong to Class XYZ, and Attribution Rule #4 can state that a secondary applicant applying for ABC checking who lives in NY can also belong to Class XYZ.

In an embodiment, there are four types of characteristics that a FI could use to create a decision class, as described below.

The user could assign an applicant to a decision class based on the type of applicant, e.g., Primary, Secondary, or Individual. This rule is an ‘OR’ conjunction. This means that the user could select one or more options. An application that meets one or more of the options would satisfy this rule. By choosing to NOT select an applicant type, the user is in effect stating that any applicant type would satisfy the rule.

Another type of characteristic is the products that are selected by the customers. The GRA module in an embodiment is pre-filled with a list of products. The list of products can originate from a data gathering form (DGF) filled out by the user. The user selects which requested products would make an applicant belong to a particular class.

This is also an ‘OR’ conjunction in which the user can select more than one product. An applicant who applies for one or more of the specified products would satisfy the requirements of this rule.

Promotion codes are another differentiating characteristic used to determine which class an applicant belongs to. The user enters one or more promotion code(s) to be used by the GRA module.

This is also an ‘OR’ conjunction in that the user can enter more than one promotion code.

From a matching perspective, the FMS can match the promotion code in the GRA module against either the promotion code passed by the FI via hypertext markup language (HTML), or entered in by a customer manually (possibly using a “Front End UI” that is distinct from the UI 118, in one embodiment).

Attribution rules can be built around the data an applicant provides in an Application Form. Each Applicant Profile rule can have multiple sub-rules, however, in an embodiment each sub-rule has only one option. For example, a rule could state that an applicant living in NY state and is an US citizen would belong to a particular class. However, a rule could not state that an applicants living in NY or NJ would belong to a particular class. More or different type of characteristics other than the four types described her can be defined in other embodiments. In order to avoid using illegal decision criteria for providing financial services, users are not able to create rules around the various dates available in the Application Profile, e.g. Driver License Dates, etc.

An FI could choose to add an attribution based on how the customer is applying for the financial product or service. The customer could be applying thru an online website, customer called into the FI call center, or the customer is using the FI kiosk at a branch or supermarket, etc.

Finally, FI could categorize their customers into new or existing customers.

At 208, the user creates a rule using one or more of these types of characteristics. If there is more than one type in an attribution rule, then this is an ‘AND’ conjunction. This means that the applicant must meet all the specific types of characteristics. For example, Attribution Rule #1 states that a primary or secondary applicant applying for Products ABC Checking or ABC Savings would belong to Class ABC. A secondary applicant applying for ABC Checking and ABC Savings would belong to Class ABC. a secondary applicant applying for EFG Savings would NOT belong to Class ABC.

At 210 the user prioritizes the Attribution Rules.

If an applicant has a profile that would allow the applicant to belong to two different decision classes, then the attribution rule with a higher priority would determine which class the applicant belongs to.

For example, attribution rule #2 says a primary applicant applying for ABC Savings with promotion codes ABC who lives in NY would belong to Class XYZ. An applicant could fall into Attribution Rule #1 and #2. Since Attribution #1 has a higher priority order, the applicant would belong to Class ABC.

When a user deletes an Attribution Rule, the FMS presents a confirmation pop-up window to verify before executing the delete request. In addition, the user must re-order the priority of the attribution rules once s/he deletes a rule.

The FMS also creates a default class called ‘Default’ at 212. The attribution rule for this class is: Applicant Type=ANY, Products=ANY, Promotion code=ANY, and Applicant Profile rule=NONE. This class is designed as a ‘catch-all’ class, so that if there are any lapses in the attribution rules (as configured by the FI) that cause an applicant to be without a decision class, the applicant is placed in the default class. A user cannot change the attribution rules of the default class or delete the default class.

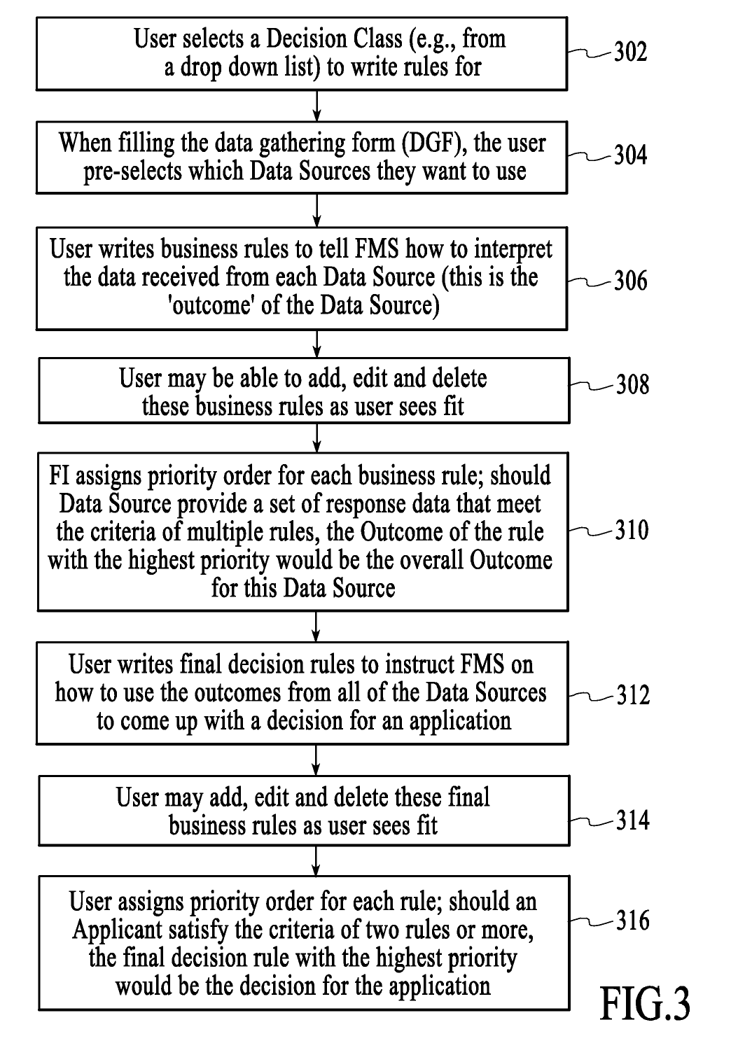

FIG. 3 is a flow diagram illustrating selection of data sources and creation of rules for classes according to an embodiment. The user creates a decision class that has attribution rule(s) assigned against it. There should be at least one attribution rule per class. Then the user writes data source business rules and final decision rules for that particular class.

To select the decision class s/he wants to write rules for, the user selects that decision class from a drop down list presented in the UI, as shown at 302. When filling the data gathering form (DGF, which is not shown), the user pre-selects which data sources to use, as shown at 304. In an embodiment, available data sources include one or more of the following:

eID Verifier;

eID Compare;

Verid;

ChexSystem;

Qualifile;

Trans Union;

Quova;

OFAC; and

Applicant Profile (as entered by the applicant).

In other embodiments, there may be more or less data sources, or different data sources.

Once the data sources are selected through the DGF, they appear in the GRA section of a UI screen created for the particular FI. FIs are able to create business rules for these data sources and use these data sources in their final decision rule. The user writes business rules at 306 to tell the FMS how to interpret the data received from each data source (this is the ‘outcome’ of the Data Source). For some data sources, the business rules must be comprehensive enough to cover all scenarios and possible response combination. For other data sources, the business rules only need to cover the scenarios that the user would like to cover. Users may able to add, edit and delete these business rules as they see fit, as shown at 308.

Users are able to write different business rules for the same data source for each decision class. For example, the user writes a rule that puts all applicants with a score of 90 from eID Verifier in the ‘Hard Pass’ Outcome in Decision Class ABC. While in Decision Class 123, all applicants with a score of 90 from eID Verifier are put into the ‘Hard Fail’ Outcome.

The FI assigns priority order for each business rule at 310. Should a data source provide a set of response data that meets the criteria of multiple rules, the outcome of the rule with the highest priority would be the overall outcome for this data source.

A sample business rule is: If eID Verifier presents a score of 90 and Reason Codes 12, 13, 14, then put the applicant into ‘Soft Pass’.

The user writes final decision rules at 312 to instruct the FMS on how to use the outcomes from all of the Data Sources to come up with a decision for an application. The final decision rules should be comprehensive enough to cover all scenarios and possible combination from all the data sources.

Users may add, edit and delete these final decision rules as they see fit, as shown at 314.

Similar to data source business rules, users are able to write different final decision rules for each decision class.

In an embodiment, there are three possible categories for an application decision: Approve, Decline, and Review. The FI may create as many decisions as they like within each of these “decision buckets”, such as Address Verification Pending, ID Verification Pending, etc.

These decision buckets are set up during DGF time. Buckets identified in the DGF are available for selection in the GRA module.

The user assigns priority order for each rule at 316. Should an applicant satisfy the criteria of two rules or more, the final decision rule with the highest priority would be the decision for the application.

A sample final decision rule is: If eID Verifier is Hard Pass, ChexSystem is Hard Pass, OFAC is No Match, and Applicant Profile is Hard Pass, then put the Applicant into the ‘Approve’ decision.

A GRA decision framework, decision classes, data sources and final decision rules will be described in greater detail below. Various screen shots, as presented to the user through the FMS UI, are in following figures for illustrating embodiments of the GRA system and method.

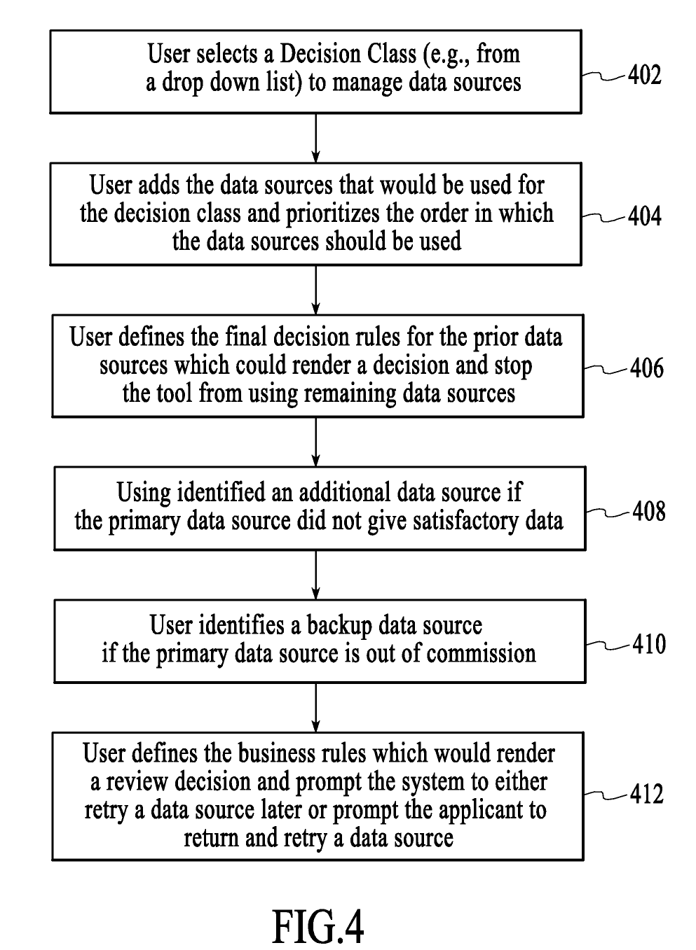

FIG. 4 is a flow diagram illustrating a process of managing the data sources according to an embodiment. The user specifies which data sources they want to use for each decision class and the order in which they should be used. The user adds business rules to specify when to stop the decision making process and render a decision. The user could add an addition data source or add a backup data source. Finally, the user could add business rules to determine when to automatically retry later or prompt the applicant to return and retry.

To select the decision class s/he wants to write rules for, the user selects that decision class from a drop down list presented in the UI, as shown at 402. When filling the data gathering form (DGF, which is not shown), the user already pre-selects which data sources to use; these data sources are presented to the user in the UI. The user chooses which data sources to be used for the selected decision class and the order in which they should be used; shown at 404.

At 406, the user adds final decision rules at logical points where a data source, or group of data sources is used. For example, user identifies data sources eID Compare, ChexSystem, Quova, and OFAC for a decision class. User then adds a set of final decision rules after eID Compare is used, another set of final decision rules after ChexSystem, and a final set of final decision rules after Quova and OFAC. The second set of final decision rules are written such that if ChexSystem gives unfavorable data for the applicant, a decline decision is rendered. Upon the calculating the decline decision, GRA will stop the decision making process and inform the applicant of the decision. Quova, and OFAC will not be used.

The user then adds an additional data source if the primary data source did not give satisfactory data. For example, user adds eID Verifier as an additional data source after eID Compare. The user would write final decision rules that would trigger the usage of eID Verifier if eID Compare gives an unfavorable data for an applicant; as shown in 408.

Furthermore, the user can identify a backup data source if the primary data source is not available. For example, GRA used ChexSystem per user's instructions. However, ChexSystem is not responding. User could add another comparable data source as a backup data source such that when ChexSystem is not responding, GRA would use backup data source instead. This is shown at 410.

At 412, user could modify the second set of final decision rules such that if ChexSystem is not responding, applicant would be given a review decision. The GRA module automatically retries ChexSystem after a period of time has elapsed. For data sources such as eID Verifier which require applicant to answer Interactive Queries, the user could set up the first set of final decision rules to render a review decision. The applicant would be instructed to return to the application at a later time. When the applicant returns, GRA would automatically retry eID Verifier, render an outcome for eID Verifier, and combine it with the outcomes from other data sources to render a final decision.

Data Gathering

Before the GRA module can render a decision, it receives two sets of data: the applicant's personal profile information, such as their home address and telephone number; and the additional data provided by the FI's designated data sources.

First, profile information is provided to the GRA module either from the UI, or via a real-time XML message if the FI is building its own UI. In one embodiment, the UI is an OpenNow™ UI (by CashEdge, Inc.). The information needed from each applicant is further described below.

The profile information is sent to all the data sources specified by the FI. Each data source analyzes the profile information, identifies the corresponding record for that profile in its own system, and returns additional information on the applicant back to the GRA module. The information returned varies by data source. Some examples include: results of the data source's attempt to verify the applicant's address; unpaid closures found in the applicant's debit history; records of fraudulent alerts found in the applicant's profile, etc.

An overview of available data sources according to an embodiment, and what type of information is provided by the data source, is provided below.

Data Gathering: Profile Requirements

The following fields are used by the GRA module. Some are marked as required (REQ) because they are required by external data sources:
1 Name Prefix
2. First Name (REQ)
3. Middle Name
4. Last Name (REQ)
5. Name Suffix
6. Date of Birth (REQ)
7. Social Security Number (REQ)
8. Current Home Address, City, State and Zip Code (REQ)
9. Previous Home Address, City, State, and Zip Code, if lived at current address less than two years (REQ)
10. Mailing Address, City, State, and Zip Code
11. Home Telephone (REQ)
12. Confirm if home telephone number is valid longer than 4 months (REQ)
13. Confirm if home telephone number is listed in the phone book (REQ)
14. Email Address (REQ)
15. Work telephone
16. Mother's Maiden Name
17. Confirm if user has valid driver's license (REQ)
18. Driver's License Number (REQ)
19. Driver's License State of Issuance (REQ)
20. Address on Driver License, State, City, and Zip Code (REQ)
21. Are you a US Citizen?
22. Are you employed?
23. Employer address

Also included in the Application Form are questions designated to collect more information regarding an applicant which is not necessary for the outside data sources but are required by each FI. An example questions is: ‘Are you a U.S. Citizen’?

Data Gathering: Interactive Queries

In an embodiment, for FIs who choose to use the data source eID Verifier provided by Equifax, applicants may be required to answer interactive queries. Once an applicant enters his/her personal information, the data is sent to eID Verifier to identify the user. eID Verifier then creates between two and six interactive questions, either “Real” or “Simulated”, based on information available on the applicant's credit file (e.g. name of mortgage lender, amount of monthly mortgage payment, student loan lender, amount of monthly student loan payment, etc.).

“Real” questions are based on actual data in the applicant's credit file, for which the correct answer is always one of the choices given to the applicant. “Simulated” questions are created by Equifax, for which the correct answer is always “None of the above”. Simulated questions are usually created for applicants with no credit file.

Data Gathering: Data Sources Overview

Embodiments of the GRA system and method provide FIs with great freedom to choose among data they want to use to make a decision on an online application for a financial product or service. One embodiment provides up to six different products from which an FI can choose, encompassing a wide range of identity/credit verification data. The various identify/credit verification products and the information they provide are described in detail below with reference to examples of UI screens viewed by the user.

Decision Framework

Once the data gathering process is complete, the GRA module begins a three-step decision making process. First, an applicant is evaluated to determine which decision class to use for decisioning. The decision class determines which set of rules to apply. Then, the GRA module computes a data source outcome based on the data from each of the data source that the FI has chosen to use. Finally, all the data source outcomes are evaluated to produce a final decision, which approves an application, declines the application, or places the applicant into manual review. FIs create their own rules for each step of the process identified above. These rules are classified as: attribution rules, which determine a decision class; business rules, which are used to calculate a data source outcome; and final decision rules which compute the decision for the applicant.

Decision Classes

The GRA module provides the FI with control over the rules used to evaluate the applicants, and also control over which applicants particular rules are to be applied to. Therefore, an FI can choose to evaluate all its applicants through the same set of business rules and final decision rules, or it can choose to assign its applicants to different classes, and assign a different set of rules to each class.

In an embodiment (as more briefly described with reference to FIGS. 2 and 3) there are four types of attributing characteristics available for use in grouping applicants: applicant type; products selected; promotion code entered by the applicant; and/or the applicant's profile. Each type of rule or characteristic is described in more detail below.

If the FI wants to apply the same set of business rules and final decision rules to all applicants, then the FI need not set up any attributions rules in the GRA module. The default class (as previously alluded to) has only one attribution rule which is designed to be a ‘catch all’ for applicants. If no attribution rules are created by the FI, all applicants fall into the default class, and the same set of rules are applied to all applicants.

Decision Classes: Types of Attribution Rues

Each attribution rule is written against one or more of the attribution characteristics and specifies a decision class for any applicant matching those characteristics. An FI can have more than one rule resulting in the same decision class.

Decision Classes: Types of Attribution Rules: Applicant Type

Applicants can be assigned to a decision class based on the type of applicant: Primary; Secondary, or Individual. The GRA user can create a rule which has more than one type of applicant. An applicant who meets any of the specified applicant types would satisfy this rule. By choosing not to select an applicant type, the user is in effect stating that any applicant type would satisfy this rule.

Decision Classes: Types of Attribution Rules: Product Selected

Applicants can be assigned to a Decision Class based on the products that are selected by the applicant. Similar to applicant type, the GRA user could create a rule with multiple products. An applicant who applies for one or more of the specified products would satisfy the requirements of this rule.

Decision Classes: Types of Attribution Rules: Promotion Codes

Applicants can be assigned to a decision class based on a promotion code. If the promotion code entered by the applicant matches any one of the codes entered by the GRA user, the applicant would belong to that class.

Decision Classes: Types of Attribution Rules: Applicant Profile

Applicants can be assigned to a decision class based on the applicant's profile information. Each Applicant Profile rule could have multiple sub-rules, however, each sub-rule would only have one option. For example: a rule could state that an applicant living in NY state and is an US citizen would belong to a particular class. However, a rule could not state that an applicants living in NY or NJ would belong to a particular class.

Decision Classes: Types of Attribution Rules: Channel

Applicant can be assigned to a decision class based on how the customer is applying for the financial product or service. The customer could be applying thru an online website, customer called into the FI call center, or the customer is using the FI kiosk at a branch or supermarket, etc.

Decision Classes: Types of Attribution Rules: Customer Type

Applicant can be assigned to a decision class based on whether the applicant is a new customer or an existing customer.

Decision Classes: Creating Attribution Rules

All attribution rules are listed in priority order. If an applicant meets the requirements of two different rules, the priority number of the rules would determine which class the applicant falls into.

FIs can create multiple attribution rules for one decision class, with a different priority number.

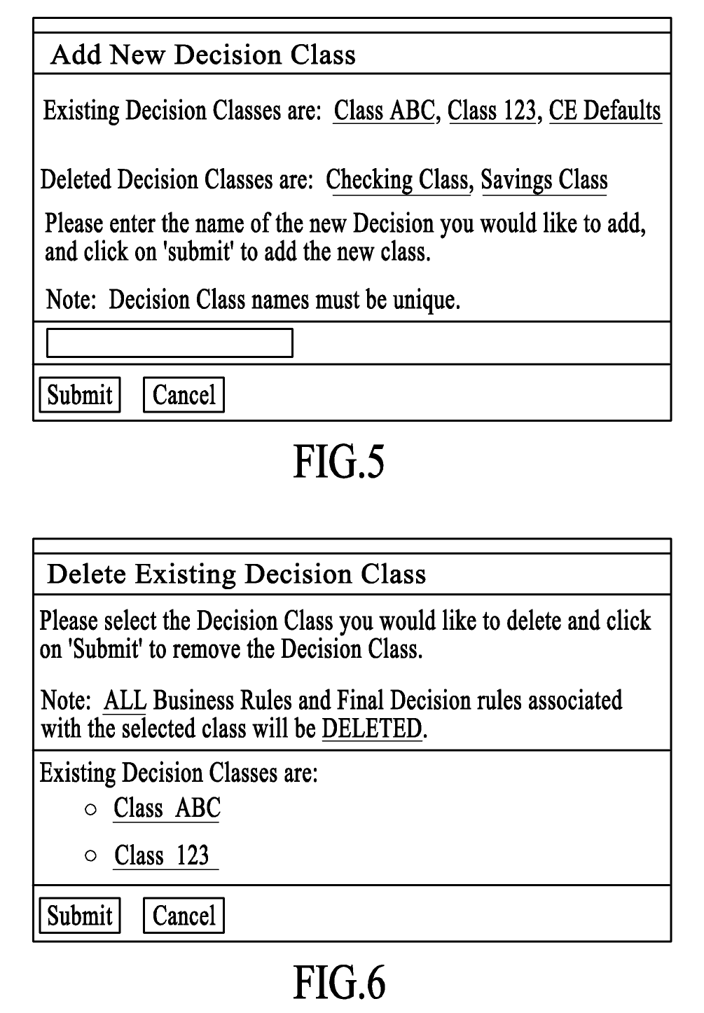

In an embodiment, there are seven functions within the GRA module that allow a GRA user to set up the attribution rules. The user first creates a decision class by entering the name of the class to be created. FIG. 5 is a UI screen for adding a decision class.

FIG. 6 is a UI screen for deleting a decision class. If the user wants to delete a class s/he created, user selects the class to be deleted.

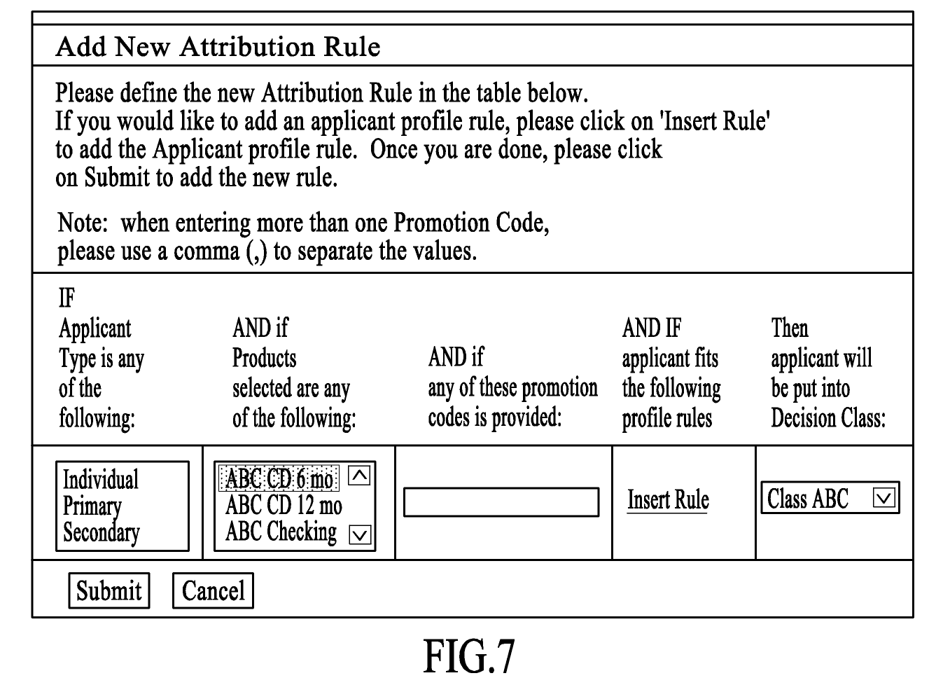

FIG. 7 is a UI screen for adding attribution rules a decision class. Once a class is created, the user adds attribution rules to that class.

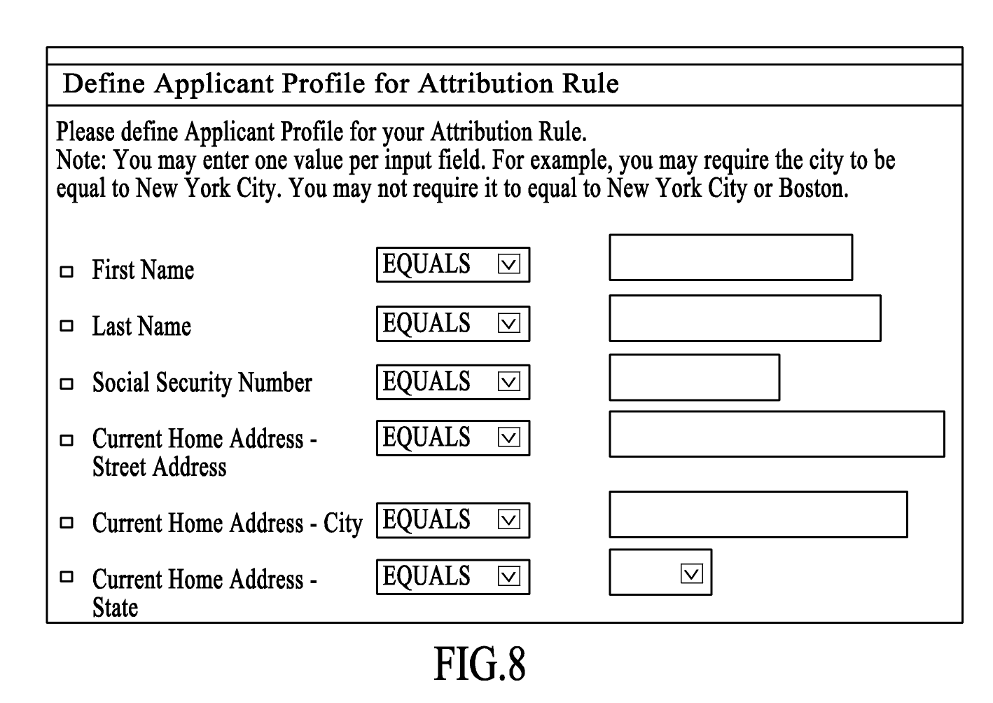

FIG. 8 is a separate UI screen for the user to select the exact applicant profile value which s/he would like to create a rule around.

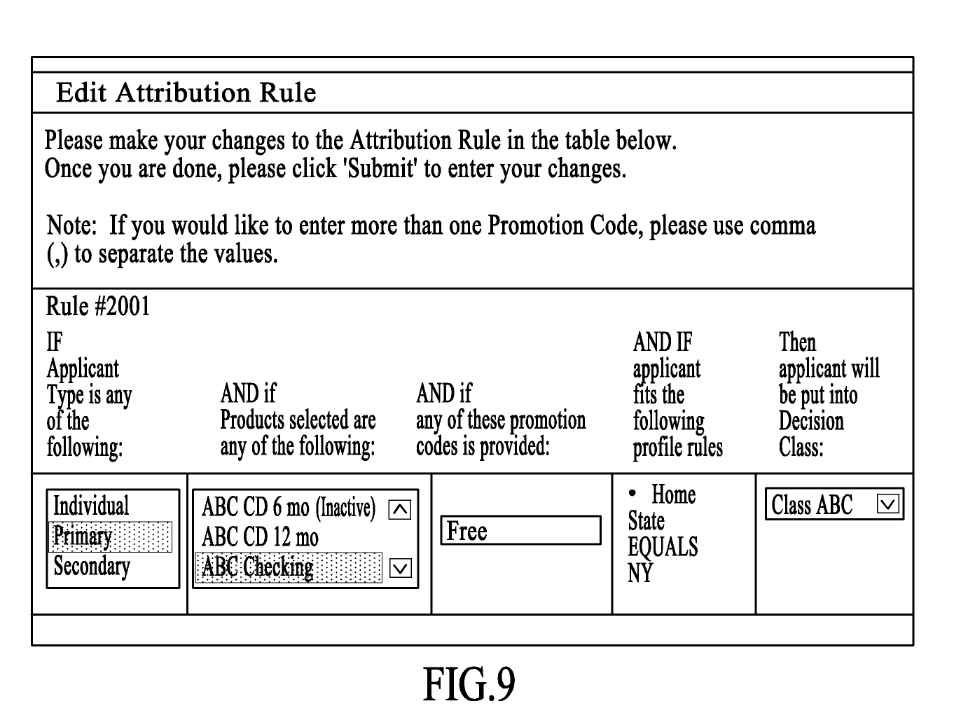

FIG. 9 is a UI screen for editing the rule. Once a rule is created, the user can edit the rule at any time.

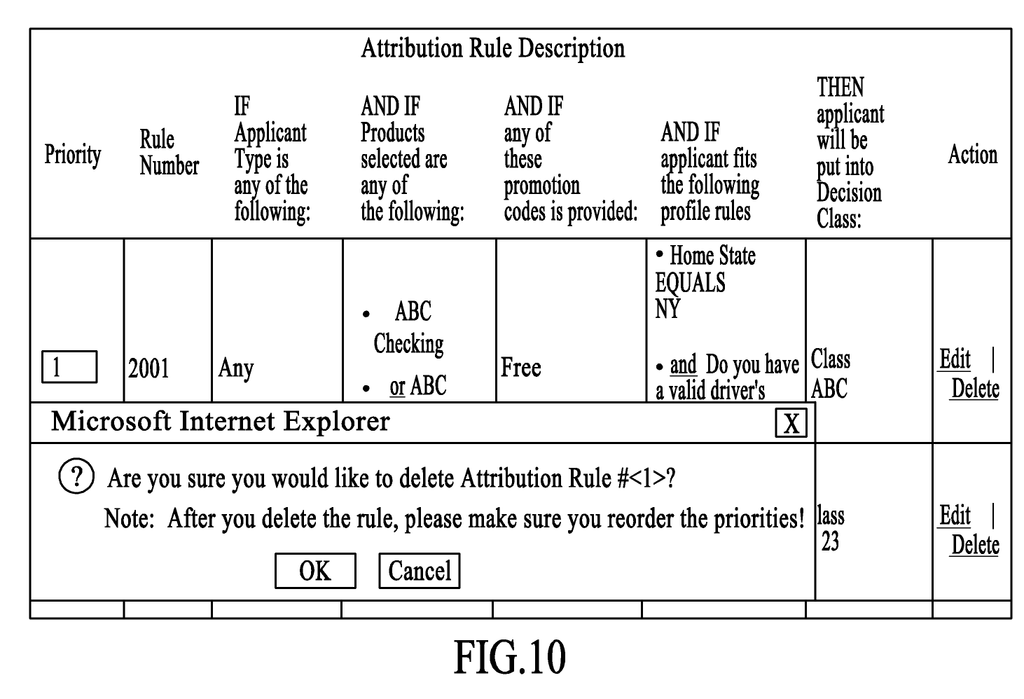

FIG. 10 is a UI screen for deleting a rule. Once a rule is created, the user can delete the rule at any time.

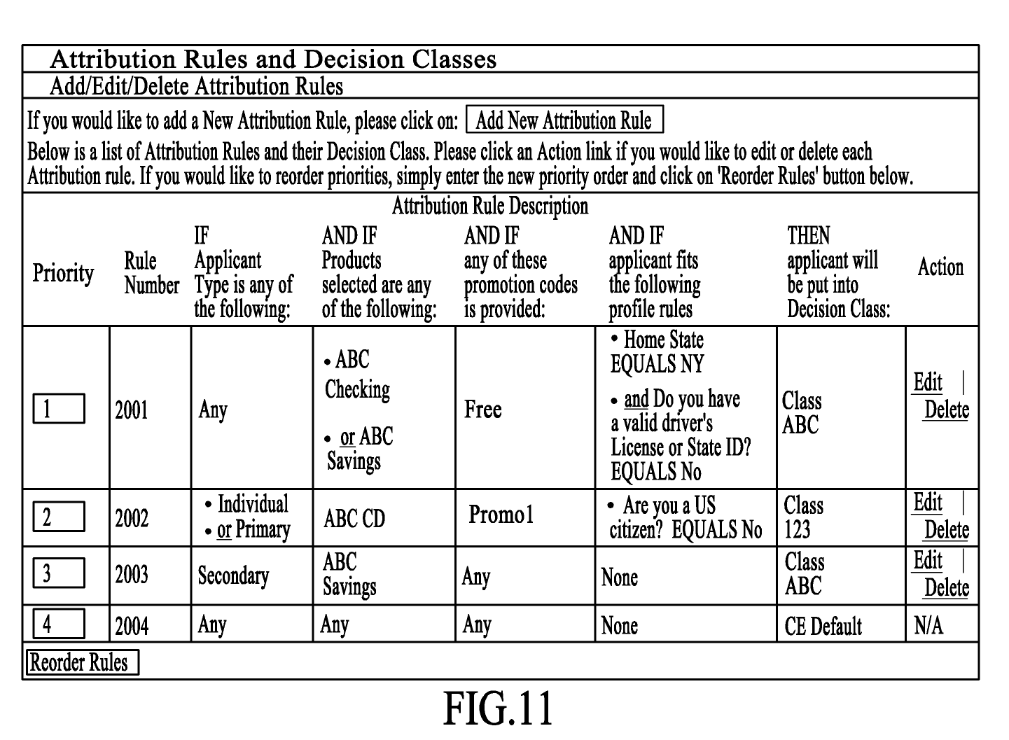

FIG. 11 is a UI screen for viewing the complete list of created attribution rules

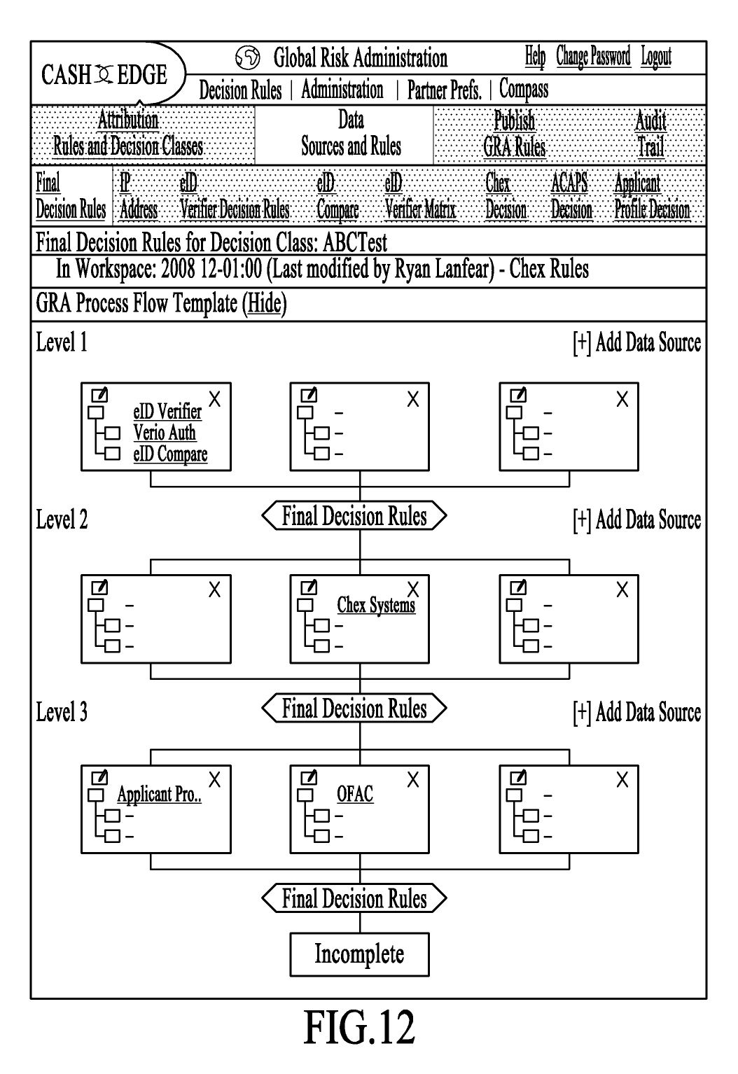

FIG. 12 is a UI screen showing sources and rules for selected decision classes. It also allows the user to manage the data sources. Once a class is created, when the user adds, deleted, or edits a data source business rule or final decision rule, the user determines which class the change(s) should be applied to. The user also uses it to define how the data sources should be managed.

Data Sources

Generally, the information that is returned from a data source is raw data. The GRA converts the raw data using the business rules to generate an outcome. For example, eID Verifier returns a list of reason codes associated with the applicant. eID Verifier business rules are used to analyze the reason codes and produce an outcome.

In an embodiment, the GRA module pre-defines the outcome values for most or all of the data sources. These outcomes are:
Hard Fail
Soft Fail
Soft Pass
Hard Pass

FI creates business rules that would assign one of these four outcomes to a combination of data elements received from eID Verifier. The FI assigns priority order for each business rule. Should eID Verifier provide a set of response data that meets the criteria of multiple rules, the outcome of the rule with the highest priority would be the overall outcome for this data source.

In an embodiment, for newer data sources (e.g. eID Compare) the partner specifies the outcome values (instead of the standard Hard Fail, Soft Fail, etc.). Some data sources actually provide a definitive input, such as approve or decline. For these data sources, no rules are needed.

Data Sources: Equifax—eID Verifier

Equifax is a credit reporting agency that provides online identity verification products. Equifax verifies consumer profile information such as age, address and SSN etc., by matching the applicant data against State Department of Motor Vehicles, telephone companies, fraud databases, and other data sources.

In an embodiment, the FMS partners with Equifax to provide FIs with the option to select between two different identity verification products: eID Verifier and eID Compare. eID Verifier and eID Compare both provides a set of Reason Codes that explains any failures to match the applicant's information with Equifax's data sources. eID Verifier takes identity verification a step further by utilizing a series of interactive questions based on the consumers' credit file to further verify customer identity.

Using responses from the various data reference providers and the applicant's answers to interactive questions, eID Verifier returns a composite score for the applicant and a set of reason codes that provide more details on the applicant's identity verification. An FI is able to create business rules around the composite score and reason codes to reach a conclusion about the applicant's identity. Business rules can be tightened or relaxed, depending on each FI's tolerance level for risk and fraud.

Data Sources: Equifax—eID Verifier: Composite Score

eID Verifier computes a Composite Score for an applicant based on his/her input data and answers to the interactive questions. There are ten potential Scores. How an applicant would score is dependent on user's answers to the interactive questions.
Correct answers to Real questions. The highest Score (90) results from correct responses to real questions and successful match of credit information, driver's license and phone number against Equifax data sources. Approximately 71% of the general population falls into this category.
Correct answers to Simulated questions. The three next highest scores are assigned to applicants who responded correctly to Simulated questions, with the highest of these scores (85) assigned to an applicant whose credit information, driver's license and phone number are all successfully matched against Equifax data sources. A score of 78 is assigned to an applicant who answers simulated questions correctly, but whose phone number did not match. A score of 74 is assigned to an applicant who answers the simulated questions correctly, but whose driver's license did not match.
Incorrect answers to Interactive questions. The remaining five scores are assigned to applicants who responded incorrectly to questions, real or simulated. Applicants whose credit information, driver's license and phone number are all successfully matched to the database receive the highest scores in this group—with those responding real questions receiving a higher Score than those responding to simulated questions (70 and 65 respectively). Applicants with good matches on credit information and driver's license and no match on phone number score next—again with those responding to real questions scoring higher than those responding to simulated questions (60 and 55 respectively). Finally, those who match only to credit information receive the lowest scores, with those responding to real questions scoring higher than those responding to simulated questions (20 and 15 respectively).

Table 1 summarizes the scores returned by eID Verifier. N/A—Not Applicable to the overall Assessment Index level.

TABLE 1

| | Interactive | | | | | | |
|---|---|---|---|---|---|---|---|
| Equifax | Question | | Database Match | | | Percent of | Recommended |
| Score | Type | Answered | Credit | DL | Phone | Population | Action |
| 90 | Real | Correct | Good | N/A | N/A | 71% | Pass |
| 85 | Simulated | Correct | Good | Good | Good | 2% | Pass |
| 78 | Simulated | Correct | Good | Good | Bad/ | 4% | Pass |
| | | | | | N/A | | |
| 74 | Simulated | Correct | Good | Bad/ | N/A | 15% | Pass |
| | | | | N/A | | | |
| 70 | Real | Incorrect | Good | Good | Good | 1% | Manual |
| | | | | | | | Review |
| 65 | Simulated | Incorrect | Good | Good | Good | 0.3% | Manual |
| | | | | | | | Review |
| 60 | Real | Incorrect | Good | Good | Bad/ | 1% | Manual |
| | | | | | N/A | | Review |
| 55 | Simulated | Incorrect | Good | Good | Bad/ | 0.5% | Manual |
| | | | | | N/A | | Review |
| 20 | Real | Incorrect | Good | Bad/ | N/A | 3% | Manual |
| | | | | N/A | | | Review |
| 15 | Simulated | Incorrect | Good | Bad/ | N/A | 1% | Manual |
| | | | | N/A | | | Review |

Data Sources: Equifax—eID Verifier: Reason Codes

eID Verifier provides the GRA module of the FMS with reason codes, which are generated by eID Verifier after each step of ID verification. Reason codes provide details on the ID verification results. Reason codes may identify a problematic social security number (SSN), address, or driver's license.

Data Sources: Equifax—eID Verifier: Creating Rules for eID Verifier

In an embodiment, eID Verifier is a data source for which the FMS has pre-defines the data source outcome values. As mentioned earlier, the values are: Hard Fail, Soft Fail, Soft Pass, and Hard Pass. eID Verifier rules are written in If/Then format. For example: if the reason codes: 123 is received, then, the outcome is: Hard Fail. Each rule is broken into 3 components: 1. what is the score received, 2. what is the reason codes received, and 3. what is the reason code NOT received. The GRA user creates a rule using one or all three components.

Each component within each rule could have more than 1 value. For example, Rule #1 could say: If score received is 0, 15, and 20 and if the reason code received are 00, 01, and 02, then the outcome is Hard Fail. If an applicant has a set of reason codes or scores that meets the requirement of two or more different rules, then CE would use the outcome of the rule with the highest priority as the outcome of eID Verifier.

A rule should be created for every known combination of score and reason code. For example, if there is a gap in the rules and the GRA module is not able to assign an eID Verifier to the applicant, then the GRA module assigns the decision of “Incomplete”.

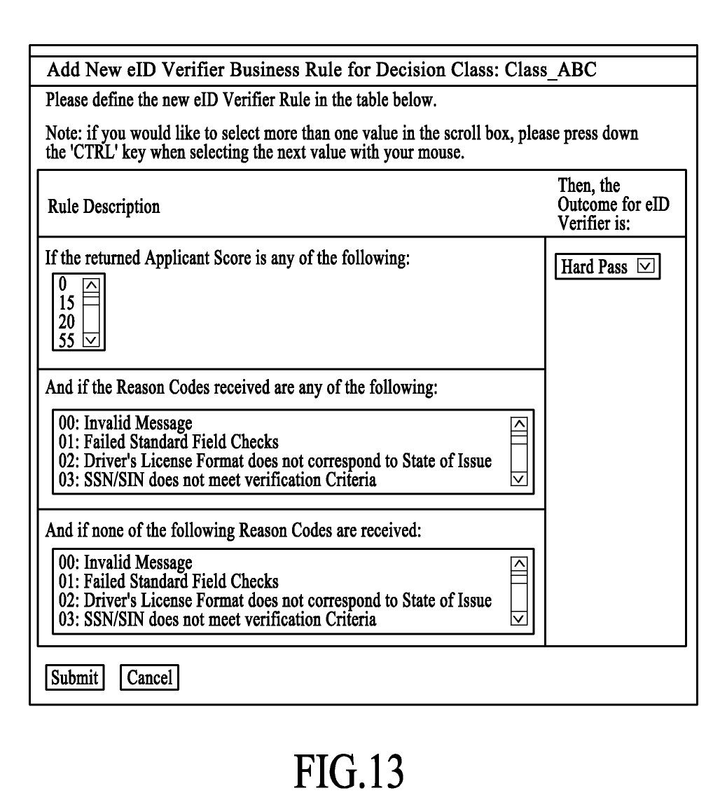

FIG. 13 is a UI screen showing the eID verifier rules. The GRA module allows the user to add, edit, delete and view the eID Verifier Rules at any time.

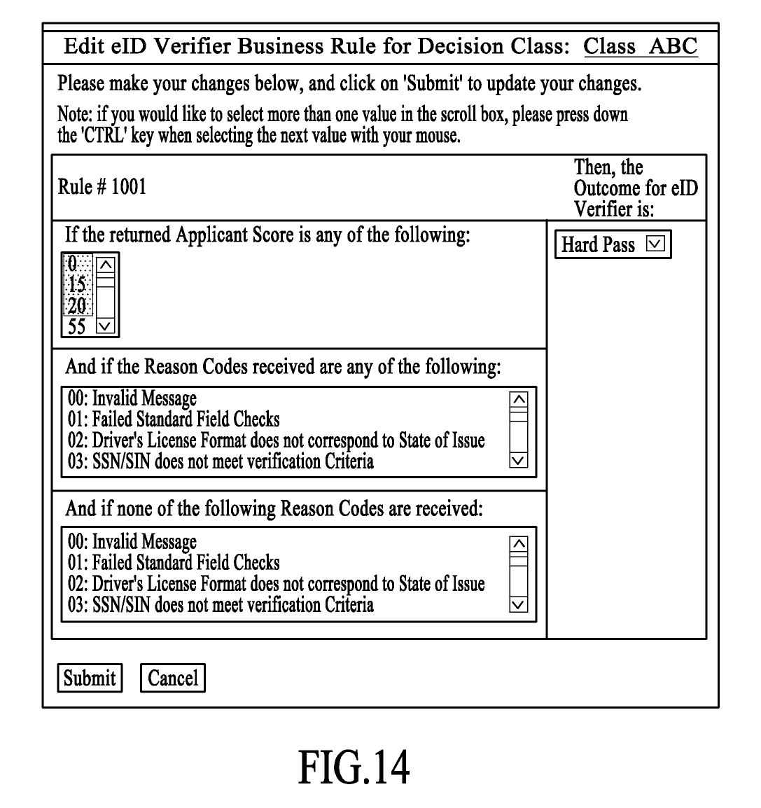

FIG. 14 is a UI screen for editing a rule. The GRA module prefills the rule with the existing rule.

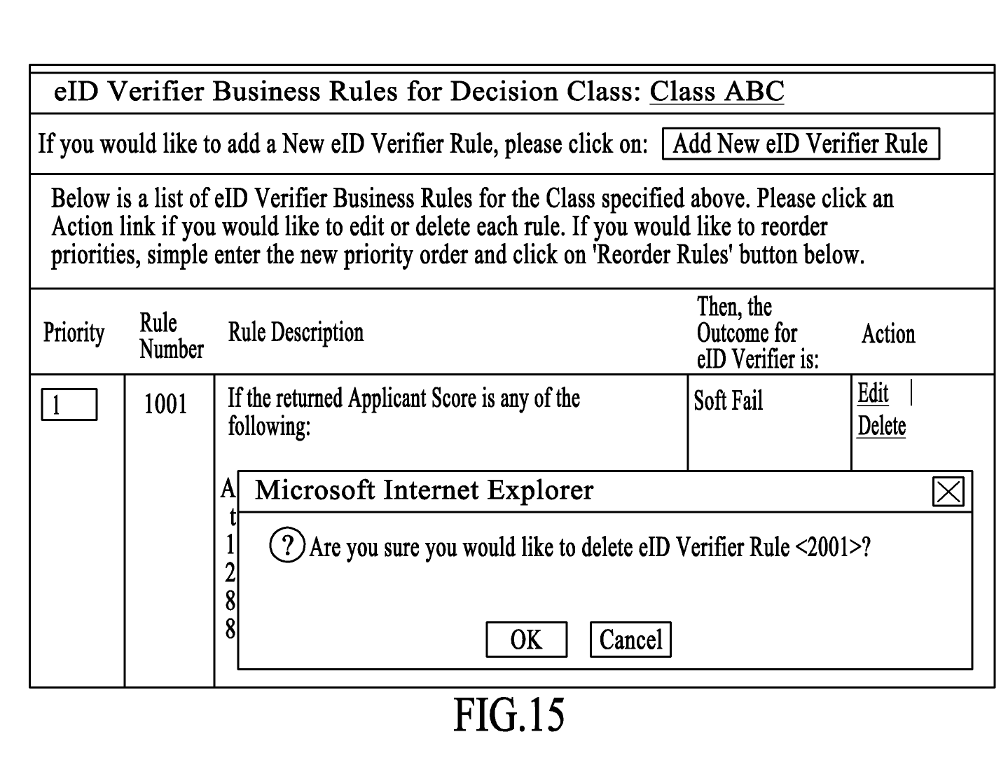

FIG. 15 is a UI screen for deleting a rule.

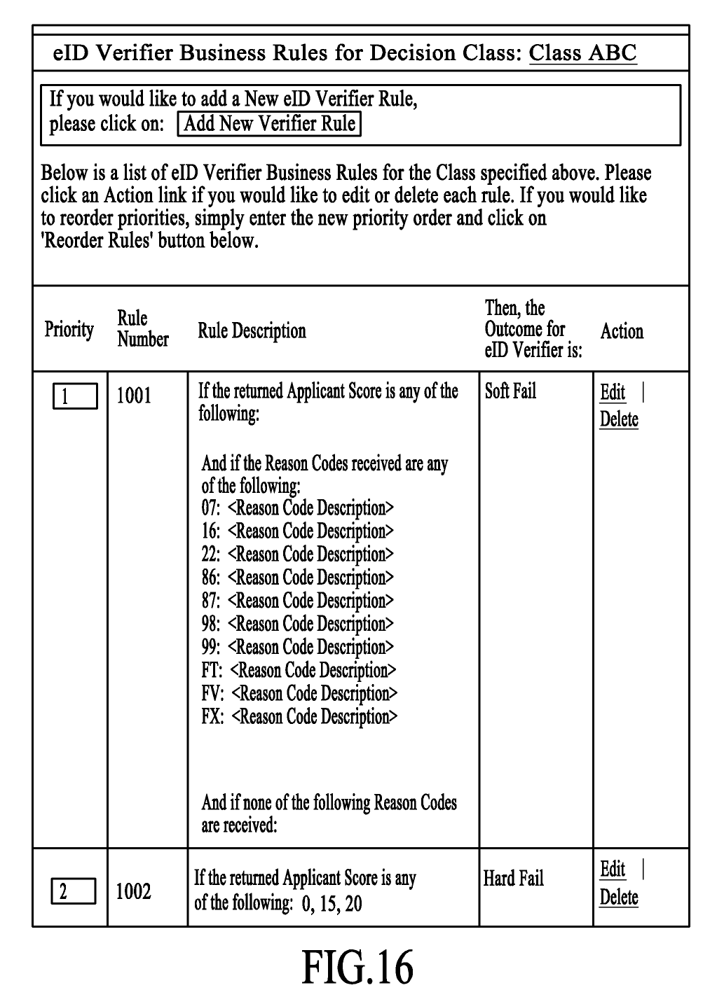

FIG. 16 is a UI screen for viewing the eID verifier rules that have been created. At any point in time, the user may view all the eID Verifier Rules created.

Data Sources: Equifax—eID Compare

As mentioned earlier, eID Compare is another product offered by Equifax for online identity verification purposes. eID Compare offers a less intrusive alternative to eID Verifier as a fraud detection solution. With minimal consumer information, eID Compare can validate the legitimacy of an identity and determine if an identity is associated with potential fraudulent activities.

Using the applicant data provided by The FMS, eID Compare provides an assessment decision recommendation, fraud indicators, match assessment and reason codes. The FI is able to create decisions rules against all of these data elements to determine a data source outcome value.

Data Sources: Equifax—eID Compare: Assessment Decision Recommendation

This is Equifax's recommendation whether or not to manually review a customer based on eID Compare assessment. The assessment recommendation is comprised of results of the fraud indicator and match assessment fields.

Data Sources: Equifax—eID Compare: Fraud Indicators

This component is an assessment of the likelihood of a consumer being associated with fraudulent activities. Table 2 below lists the various values represented by the Fraud Indicator component.

TABLE 2

| Flag | Description | Details |
|---|---|---|
| NULL | No Fraud | No Fraud Found |
| W | Fraud Warning | Only one address-related or phone |
| | | warning code returned |
| | | Fraud Victim “Temporary Fraud Alert” |
| | | Military Duty Alert |
| | | Inquiry address is associated with more |
| | | than one name or SSN, OR |
| | | SSN issued within the last 5 years AND |
| | | consumer's current address cannot be |
| | | verified |
| | | Pattern recognition match for |
| | | Same address/different SSN OR |
| | | Same Address/different last name AND |
| | | consumer's input address cannot be verified |
| V | Fraud Alert | SSN not issued |
| | | SSN reported deceased |
| | | SSN reported misused or associated with fraud |
| | | Possible True Name Fraud |
| | | Fraud Victim “Consumer Narrative Alert” |
| | | Fraud Victime “Long Term Fraud Alert” |
| | | California resident Fraud Victim Alert |
| | | Suspicious Incoming Data that has been |
| | | identified as fraudulent |
| | | SSN issued prior to DOB |
| | | Hit on Hot Address Database |
| | | Multiple warnings detected in suspicious |
| | | address and fraudulent activities |
| | | associated with submitted SSN |
| B | Fraud Alert | Combination of V & W |
| | AND Warning | |

Data Sources: Equifax—eID Compare: Match Assessment

This is the result of eID Compare's attempt to match the applicant profile information against the Equifax data sources. Possible outcome values are shown in Table 3.

TABLE 3
Possible Match Results

Name and address cannot be verified on any data source
Name and address verified on all data sources
Name and address verified on primary and secondary data sources
Name and address verified on primary and tertiary data sources
Name and address verified on primary data source
Name and address verified on secondary and tertiary data sources
Name and address verified on secondary data source
Name and address verified on tertiary data source

Data Sources: Equifax—eID Compare: Reason Codes

Reason Codes are generated from each step of the eID Compare authentication process to complement the assessment indicator. These reason codes are a subset of eID Verifier (minus the IQ result codes).

Data Sources: Equifax—eID Compare: Creating Rules in the GRA Module for eID Compare

The FMS in an embodiment, does not pre-define the data source outcome values for eID Compare. The partners should set up the outcome values when they are filling out the Data Gathering Form. eID Compare rules are written in If/Then format. Each rule is broken into five components: what is the fraud indicator; what is the match assessment; what is the assessment recommendation; what are the reason code(s) received, and what are the reason code(s) NOT received. The GRA user creates a rule using one or all five components.

Each component within a rule could have more than one value. If an applicant has a set of reason codes or scores that meets the requirement of two or more different rules, then the FMS uses the outcome of the rule with the highest priority as the outcome of eID Compare. The GRA module allows the user to add, edit, delete, or view the eID Compare Rules at any time.

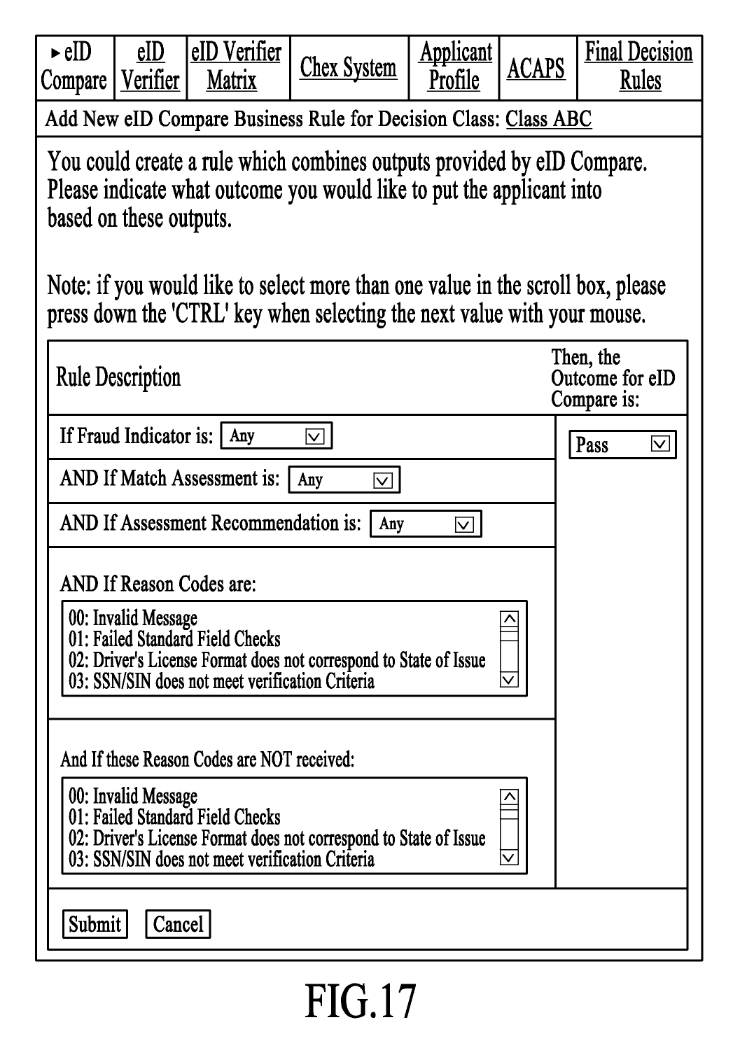

FIG. 17 is a UI screen for adding the eID compare rules.

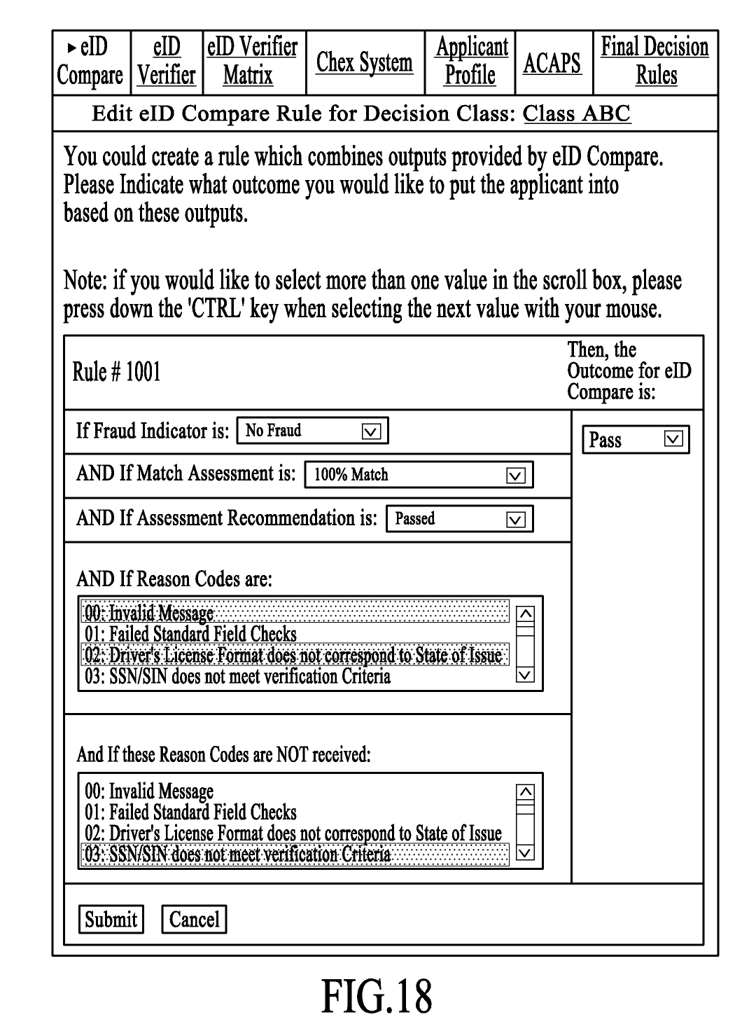

FIG. 18 is a UI screen for editing the eID compare rules. The GRA module pre-fills a rule with the original rule.

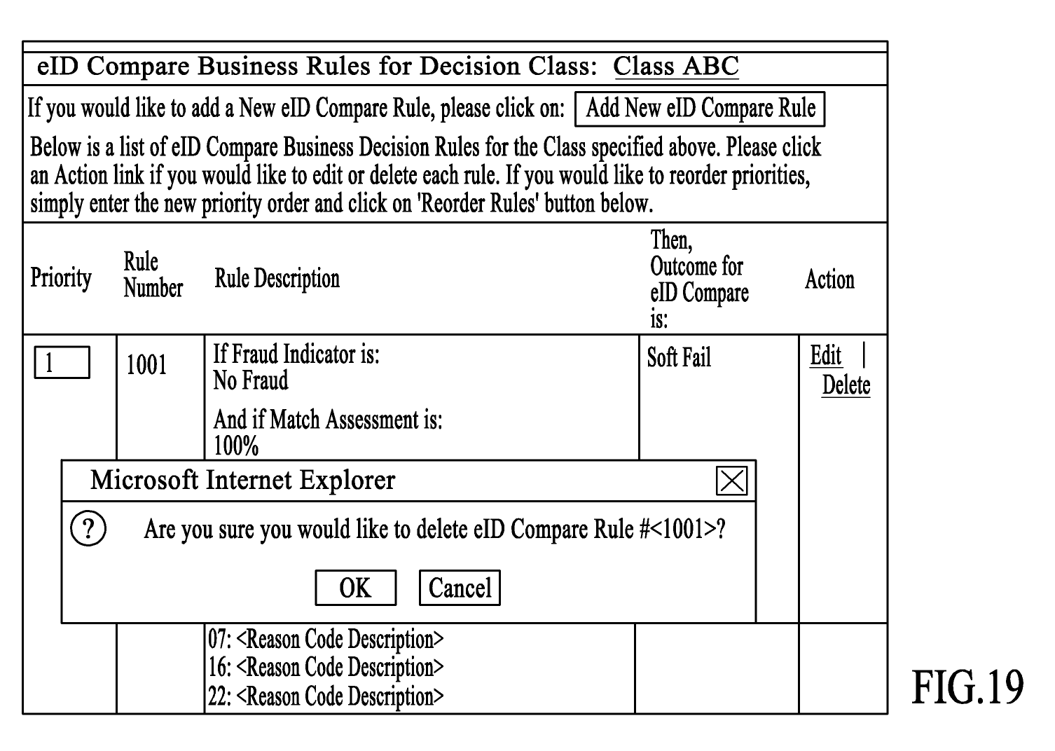

FIG. 19 is a UI screen for deleting an eID compare rule.

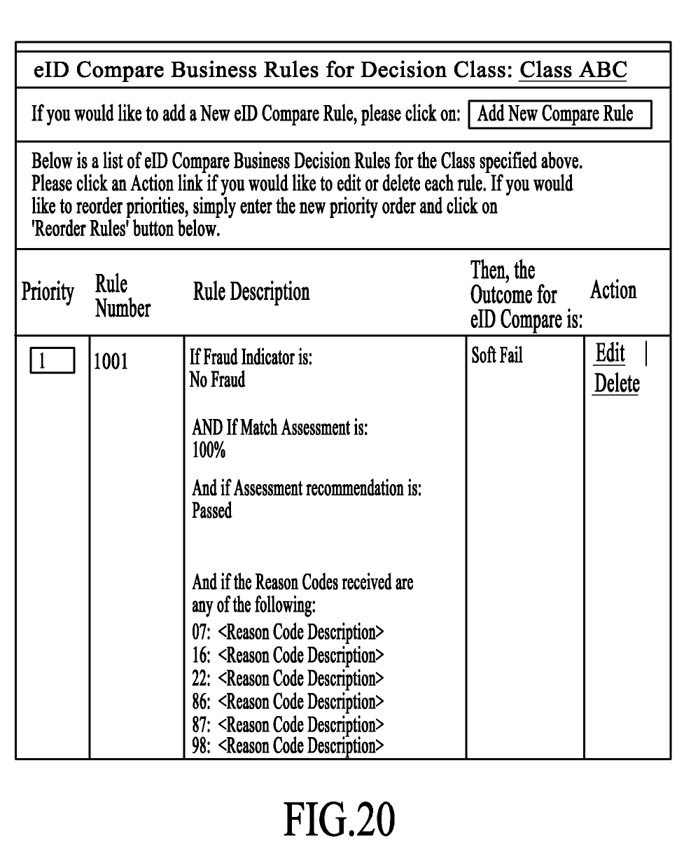

FIG. 20 is a UI screen for viewing all of the eID compare rules that have been created.

Data Sources: Efunds: ChexSystems

Efund's ChexSystems network is made up of member banks and credit unions that regularly contribute information on mishandled checking and savings accounts to a central location. This information is shared among member institutions to help them assess the risk of opening new accounts. For each applicant, ChexSystems provides data on account closures, including the quantity of reported account closures and charge off amounts associated with account closures.

In an embodiment, for each applicant, ChexSystems provides the FMS with eight different data elements, which the GRA user could use to make rules with. These data elements are: closures not found; paid closure quantity; unpaid closure quantity; original charge-off amount; please call code; previous inquiry quantity; number of inquiring institution; and social security number validation result.

Data Sources: Efunds: ChexSystems: Closure Not Found

This data element indicates whether or not reported account closures are found for the applicant. This value is either positive or negative.

Data Sources: Efunds: ChexSystems: Paid Closure Quantity

This displays the number of reported closures for which the applicant settled any outstanding balance. This data element is used in conjunction with an Original Charge-Off Amount. FIs can create this rule multiple times allowing for different, unique conditions to return specified outcomes. For example, if paid closure quantity is greater than or equal to 2 and original charge off amount is greater than or equal to $250.00 then “Hard Fail”. As another example, if paid closure quantity is less than or equal to 0 then “Hard Pass”.

Data Sources: Efunds: ChexSystems: Unpaid Closure Quantity

This displays the number of reported closures for which the applicant did not settle any outstanding balance. This data element is used in conjunction with the Original Charge-Off Amount. FIs can create this rule multiple times allowing for different, unique conditions to return specified outcomes.

Data Sources: Efunds: ChexSystems: Original Charge-Off Amount

This is the original amount charged off by the reporting financial institution at the time the account was closed. This amount is either associated with a paid or unpaid closure.

Data Sources: Efunds: ChexSystems: Please Call Code

This data element is either positive or negative. If the value is positive, then this is an indicator that some information that is unclear or suspicious about the applicant's data record.

Data Sources: Efunds: ChexSystems: Previous Inquires Quantity

This shows the number of previous inquiries that have been made by financial institutions about this applicant. FIs can also create rules around the number of inquiries made against an applicant with or without the conjunction of the number of inquiring institutions. An example would be: if Number of previous inquiries about the applicant is equal or greater than 6 AND the Number of inquiring institutions is 4, then Soft Fail.

Data Sources: Efunds: ChexSystems: Number of Inquiring Institutions

This shows the number of institutions that have made previous inquiries about the applicant. The FI can create a decision rule based on the number of inquiring institutions with or without the conjunction of the number of inquiries made against an applicant; such that FI could create a rule to state that if the number of inquiring institutions is greater than 5, then Hard Fail.

Data Sources: Efunds: ChexSystems: SSN

This data element indicates whether the SSN for this applicant is valid or not based on ChexSystems data sources.

Data Sources: Efunds: ChexSystems: Creating Rules for ChexSystems

In an embodiment, the FMS pre-defines the data source outcome values for ChexSystems. The values are: Hard Fail, Soft Fail, Soft Pass, and Hard Pass. ChexSystems rules are written in If/Then format. Each rule has at least one required clause. Required fields are marked with an asterisk. The rule may also have an optional clause. Due to the nature of certain data elements, the rules created against them are exclusive. For example, if the user created a rule: if closure not found is true, then Hard Pass, the user would not be able to create another rule that conflicts with this statement, such as: if closure not found is true, then Hard Fail. If an applicant meets the requirement of two or more different rules, the worst of the outcomes would become the outcome of ChexSystem.

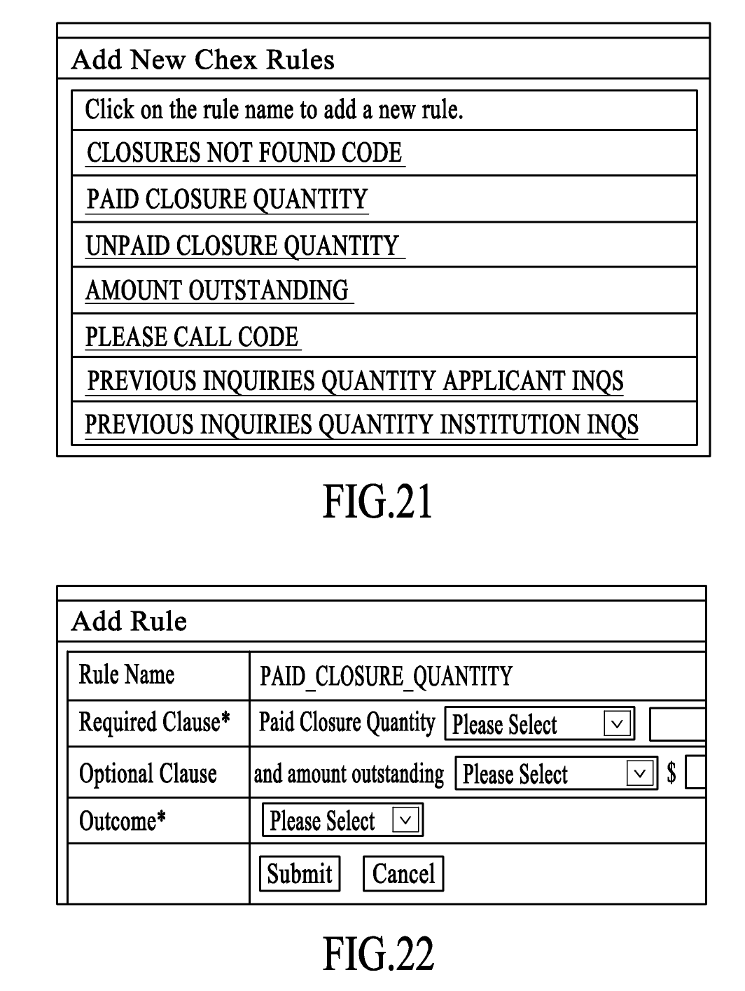

FIG. 21 is a UI screen for adding new ChexSystem Rules. The GRA allows the user to add, edit, delete, or view the ChexSystem Rules at any time. To add a rule, the user clicks on a specific rule name to be added.

FIG. 22 is a UI screen to which the user is directed after clicking on a name in FIG. 21. A specific version of the rule can be submitted on this screen.

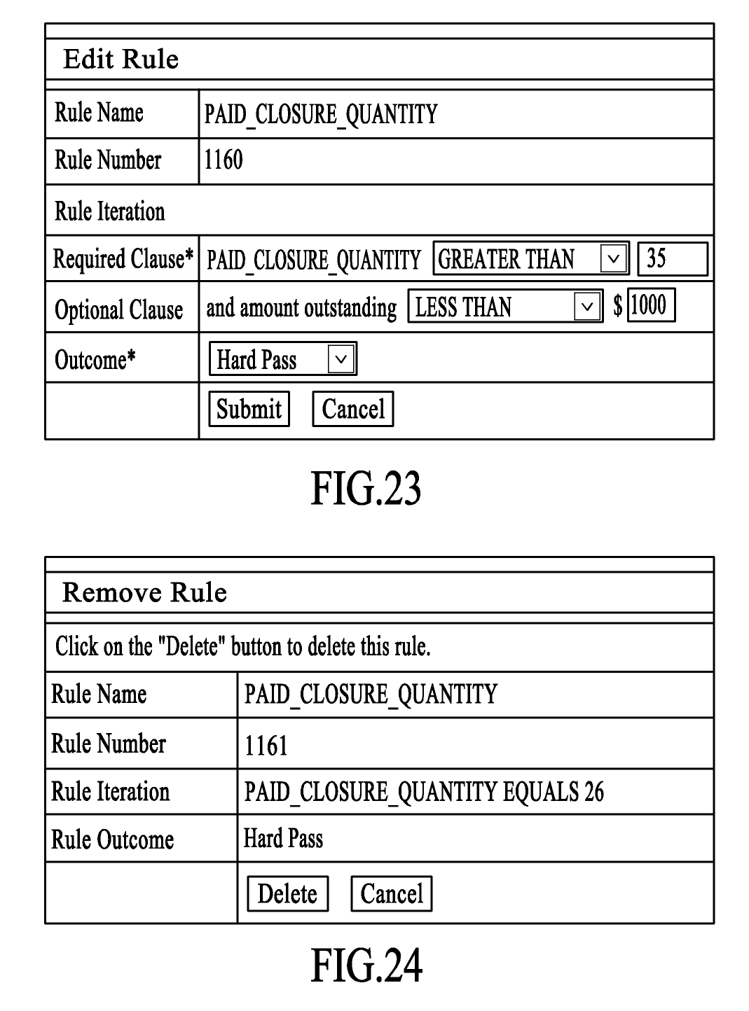

FIG. 23 is a UI screen editing a rule.

FIG. 24 is a UI screen for deleting a rule.

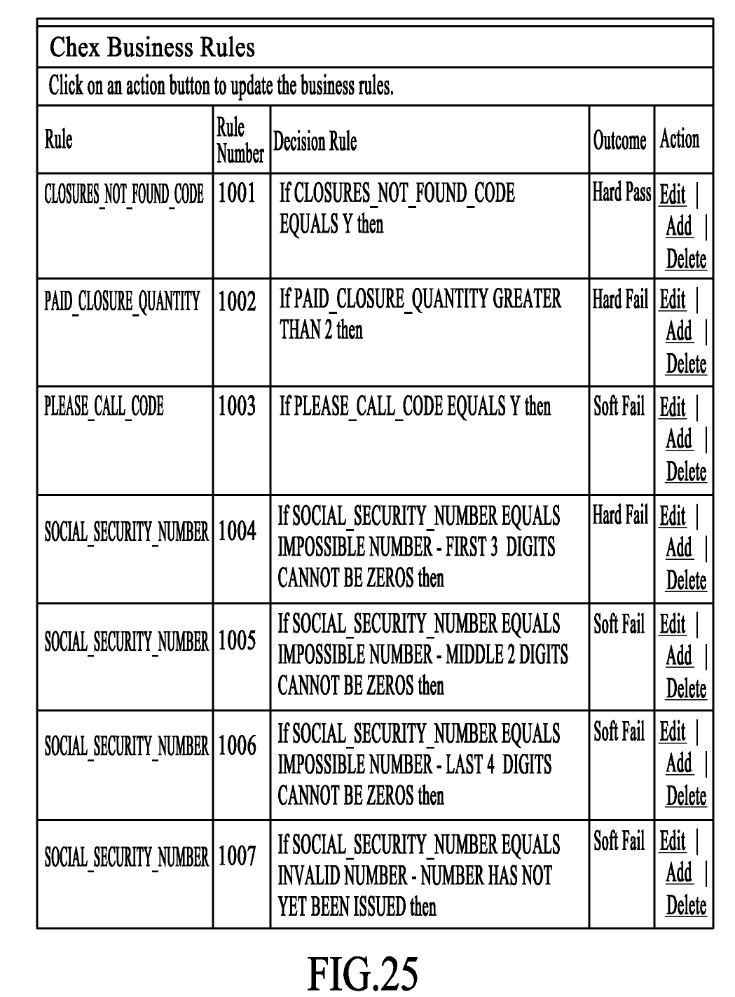

FIG. 25 is a UI screen to view all the rules associated with ChexSystems.

Data Sources: Efunds: ChexSystems: Setting Up ChexSystems

As mentioned earlier, ChexSystems is created through a network of Banks and Credit Unions. In most cases, an FI is an existing client of ChexSystems before using ChexSystems through the FMS. If that is the case, then the FI would most likely have a link already set up with ChexSystems to receive and send information.

The link between CashEdge and ChexSystems is independent of the link between the FI and ChexSystems. It is the FI's responsibility to ensure that the business rules being set up in GRA for ChexSystems data is consistent with the FI's existing business rules regarding ChexSystems data outside of the FMS.

For example, an FI might have a corporate policy to ignore any closures that are more than one year old. This rule is the one being observed and executed at the retail branch. It is this FI's responsibility to ensure a similar rule is set up in GRA for ChexSystems to ensure the corporate policy is also observed in the online channel.

Data Sources: Efunds: Qualifile

Qualifile, a product made available by Efunds, further complements the ChexSystem data by combining debit, credit, demographic and financial product usage data to FIs. The FI must be a user of ChexSystem in order to use Qualifile. After evaluating the applicant profile information sent by the FMS, Qualifile provides a recommendation of approve, review, or to decline the applicant.

Data Sources: Efunds: Qualifile: Creating Rules for Qualifile

In an embodiment, the FMS pre-defines the data source outcome values for Qualifile. Qualifile provide three possible responses to the FMS: approve, review and decline. The FI assigns a Qualifile outcome decision of Hard Pass, Soft Pass, Soft Fail, and Hard Fail to each of the three responses from Qualifile. Qualifile rules are written in If/Then format. Due to the nature of the data element, the rules created against them are exclusive. Users are not able to enter conflicting rules. In an embodiment of the GRA module, Qualifile is combined with a ChexSystems section, and some of the screens, such as list of the rules, are shared. The GRA module allows the user to add, edit, delete, or view the Qualifile Business Rules any time they want. The user can also use the same screens identified in FIGS. 20-25 to manage Qualifile rules.

Data Sources: Efunds: Qualifile: Setting up Qualifile Rules

In most cases, Qualifile is an application already used by a FI in its offline account opening process (or branch originated accounts). Decision rules against Qualifile in the online account opening process should be the same as the rules in the offline account opening process.

Data Sources: Office of Foreign Assets Control (“OFAC”)

The Office of Foreign Assets Control (“OFAC”) is a department within the U.S. Department of the Treasury. OFAC administers and enforces economic and trade sanctions based on US foreign policy and national security goals against targeted foreign countries, terrorists, international narcotics traffickers, and those engaged in activities related to the proliferation of weapons of mass destruction.

The FMS automatically checks customer data against the OFAC database of known terrorists (and other prohibited individuals). The response to the FMS is binary—either positive or negative. A positive response indicates that the applicant's name is in the OFAC database and results in a match for OFAC. A negative response results in a no match for OFAC.

Data Sources: OFAC: Creating Rules for OFAC

OFAC business rules are automatically set in the GRA module. Results of “match” or “no match” are the only responses provided for OFAC. FIs should set a rule in the Final Decision Matrix which states that any match on the OFAC database results in a final decision outcome of “Review”. Due to the nature of the OFAC database, there are a significant number of false identifications. Thorough manual verification is warranted in these circumstances.

Data Sources: Applicant Profile

The Applicant Profile Source is an internal data source which contains all data elements collected from an applicant, such as First Name, Last Name, Address, State, Phone, etc. FIs can create business rules around the customer's profile reach a decision.

Data Sources: Applicant Profile: Creating Rules for Applicant Profile

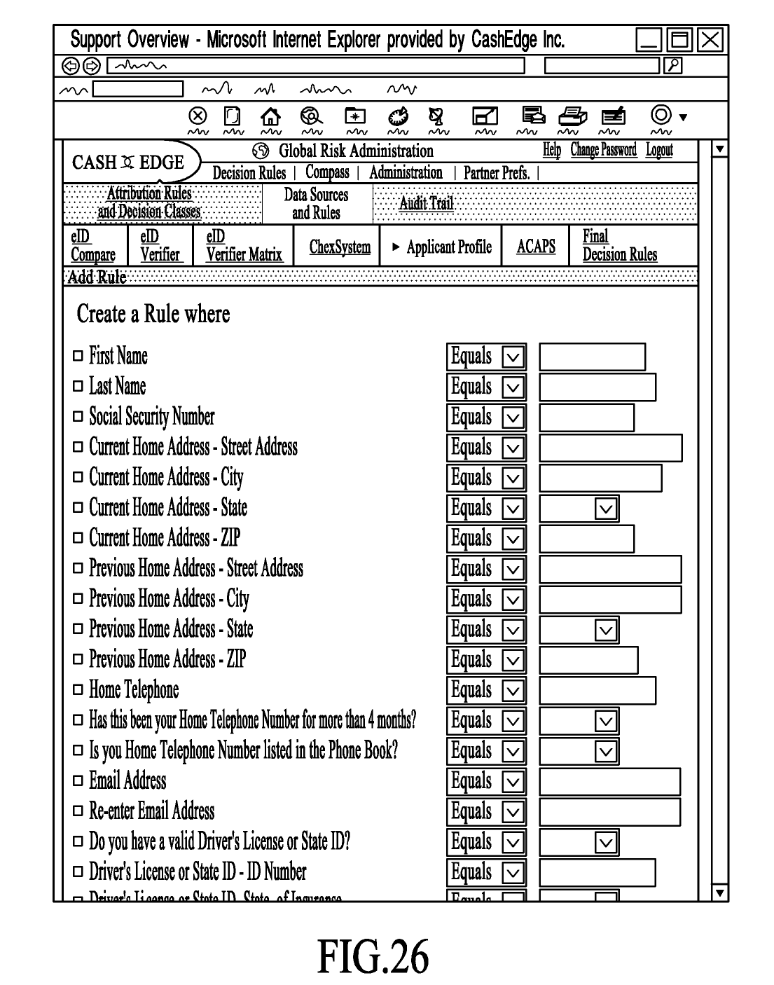

Answers to Applicant Profile Questions are either ‘free form’ or selected from a drop down menu. That is when creating an Applicant Profile business rule, a user either selects the value from a drop down menu or enter free form. The type of answer available corresponds to the question on the online application form. In an embodiment, the FMS pre-defines the data source outcome values for Applicant Profile. The values are: Hard Pass, Soft Pass, Soft Fail, and Hard Fail. Applicant Profile rules are written in If/Then format. The outcome value for Applicant Profile is the worst of all outcomes should match to multiple rules occurs. The GRA module allows the user to add, edit, or delete the Applicant Profile business rules at any time. FIG. 26 is a UI screen for adding an applicant profile rule.

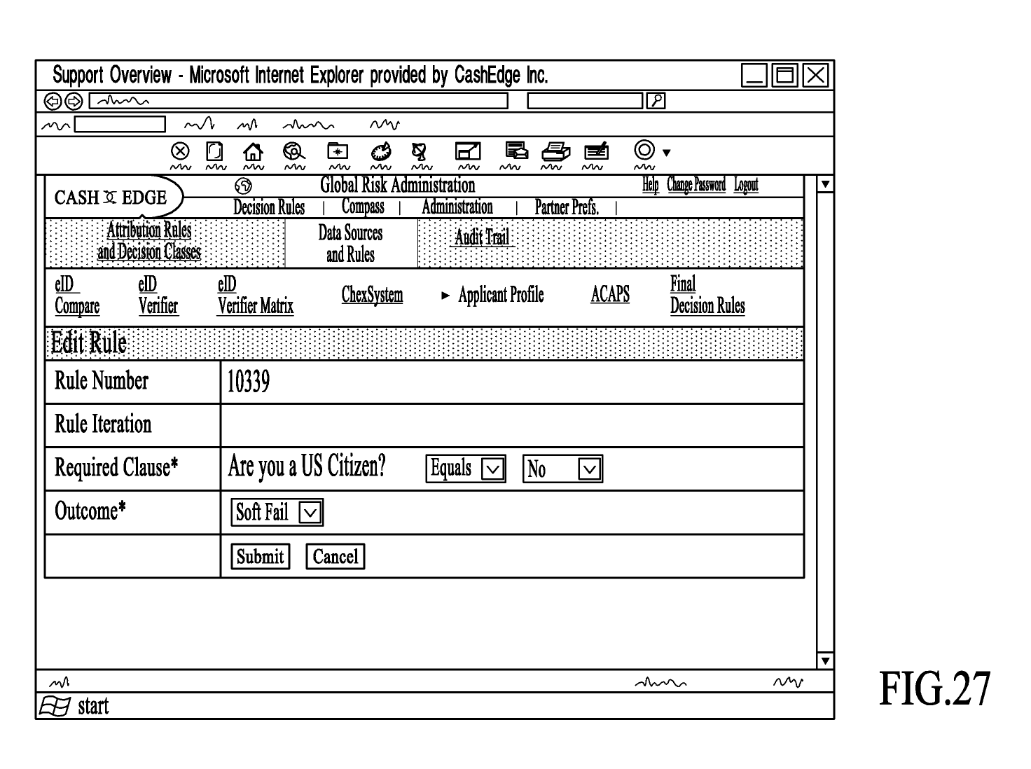

FIG. 27 is a UI screen for editing an applicant profile rule.

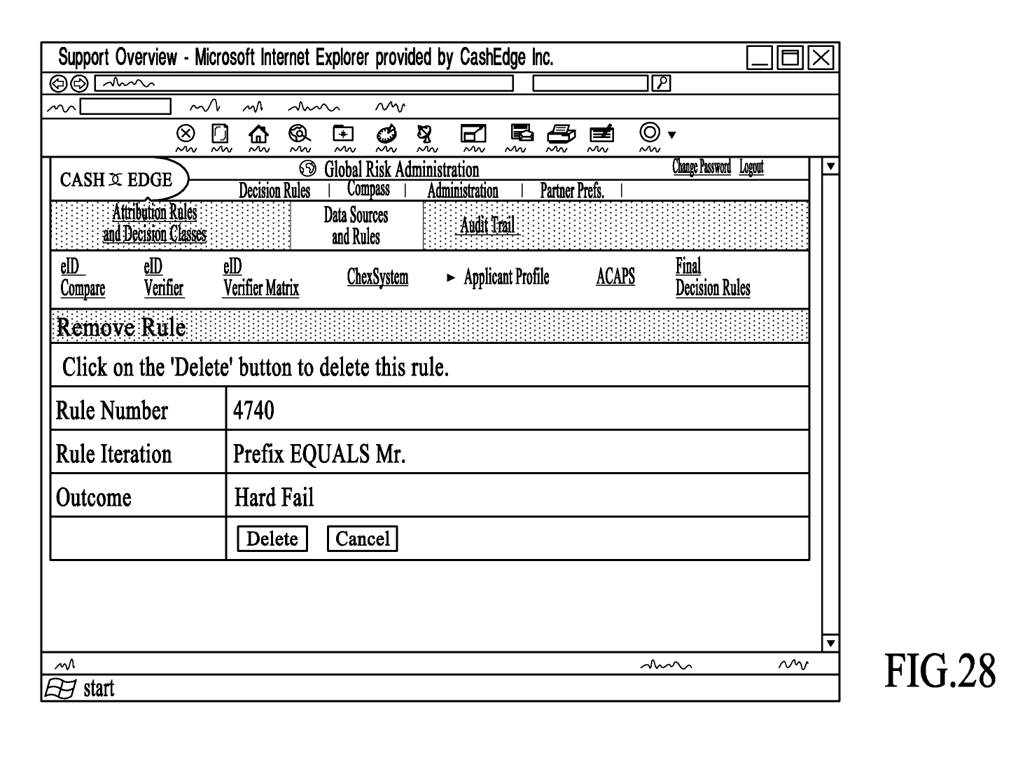

FIG. 28 is a UI screen for deleting an applicant profile rule.

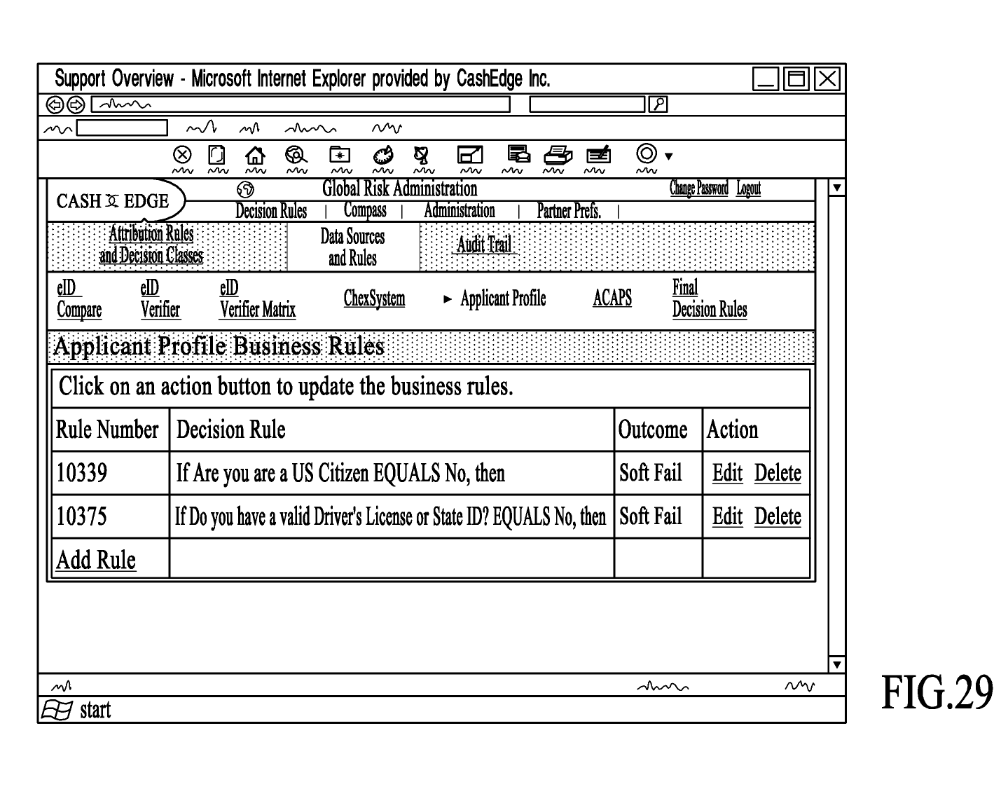

FIG. 29 is a UI screen for viewing all of the applicant profile rules that have been created.

Final Decision Rules

After the applicant is assigned to a class and the GRA module has computed the data source outcomes based on the data source business rules associated with that class, the GRA module computes a final decision based on the final decision rules the FI has set up for that class.

The Final Decision Rules, as implied in its name, is the last step in the decision making process and it computes a final decision based on the outcomes of all the data sources. A sample final decision is: if eID Verifier is Hard Pass, ChexSystems is Hard Pass, OFAC is no match, and Applicant Profile is Hard Pass, then Approve. The data sources available in the final decision rule will vary based on the data sources the FI selected to utilize for each decision class. For example, if the partner is using eID Verifier, ChexSystems, OFAC, and Applicant Profile, then these are the only data sources which the user would use in his/her final decision rule (e.g., eID Compare and Qualifile would not appear).

Final Decision Rules: Categories of Final Decisions

In an embodiment, there are three categories of account opening decisions, and the FMS has pre-defined decisions for each category. For the Pending Review category, FIs are able to create addition decisions if they desire to. Below are the three categories of decisions and the FMS defined decisions according to an embodiment:

Approved: a) Approve

Pending Review: a) Approved Pending Address Verification; b) Review; c)

Incomplete; d) eID Verifier Incomplete; e) FI could set up more review decisions

Declined: a) Declined FCRA; b) Declined non-FCRA; and c) Fraud

These rules are listed in the order of severity, from least to worst, with Approved being the best decision and Fraud the worst. Once the GRA final decision is made, there are three possible scenarios in which the decision would need to be changed. 1) The GRA decision was one of the Pending Review decisions, in which case the FMS customer service representative (CSR) would need to manually render a decision of either approve or decline. 2) The GRA decision was incomplete due to an incomplete application form, the applicant needs to complete the application, which would automatically trigger GRA to assign a new final decision. 3) The GRA decision was incomplete due to a gap in the FI rules, in which case, the FI would need to manually render a decision.

A FI would typically want to have as few applications as possible in the three scenarios outlined above because Pending Review and Incomplete decisions are interim decisions. The ultimate goal of the FI is to approve or decline the applicant. As noted above, the interim decisions require manual intervention by the FI to research and update the decision to either approve or decline the applicant.

Final Decision Rules: Categories of Final Decisions: Approved

Approved applicants are typically applicants who have met the FI's standard for risk and fraud.

Final Decision Rules: Categories of Final Decisions: Review

Pending Review applicants are usually those whom a FI did not want to decline immediately, but could not approve due to insufficient/incorrect information being provided by the applicant. The FI then sets up a workflow to follow up with the applicant and receive additional information or credentials required by the FI to make the final decision.

Final Decision Rules: Categories of Final Decisions: Incomplete

Incomplete decisions are rendered when there is a gap in the final decision rules created by the FI, one of the data sources did not respond when the FMS tried to retrieve additional data on the applicant from that source, or the applicant has not completed the online application form.

Final Decision Rules: Categories of Final Decisions: Declined

Declined applicants are usually applicants whom the FI deems to be too great a risk.

Final Decision Rules: How to Create Final Decision Rules

If there is no matching final decision rule, then the final decision will be Incomplete. If the applicant does not have a complete set of data source results (i.e. one of the data sources has an outcome of Incomplete), the final decision for the applicant is Incomplete. If the eID Verifier data source has an incomplete outcome, then the final decision will be eID Verifier Incomplete.

The GRA module does not allow users to create conflicting rules or to create the same rule twice. An error is presented if conflicting rules or same rules are detected.

If an applicant has a set of outcomes that meets the requirement of two or more different rules, then the FMS uses the decision of the rule with the highest priority as the decision of the application.

Each applicant's data is processed uniquely in the GRA system and method. In the case of a joint application, each applicant is given a decision. The Final decisions are compared and further processed such that one final application outcome is achieved for a joint application.

The Combined Decision for an application is reached by taking the most severe of the two applicant's final decision. The severity order is as follows (highest to lowest): Fraud, Declined FCRA, Declined non-FCRA, Incomplete, eID Verifier Incomplete, Approved Pending Address Verification, Review, other review decisions added by FI and Approve.

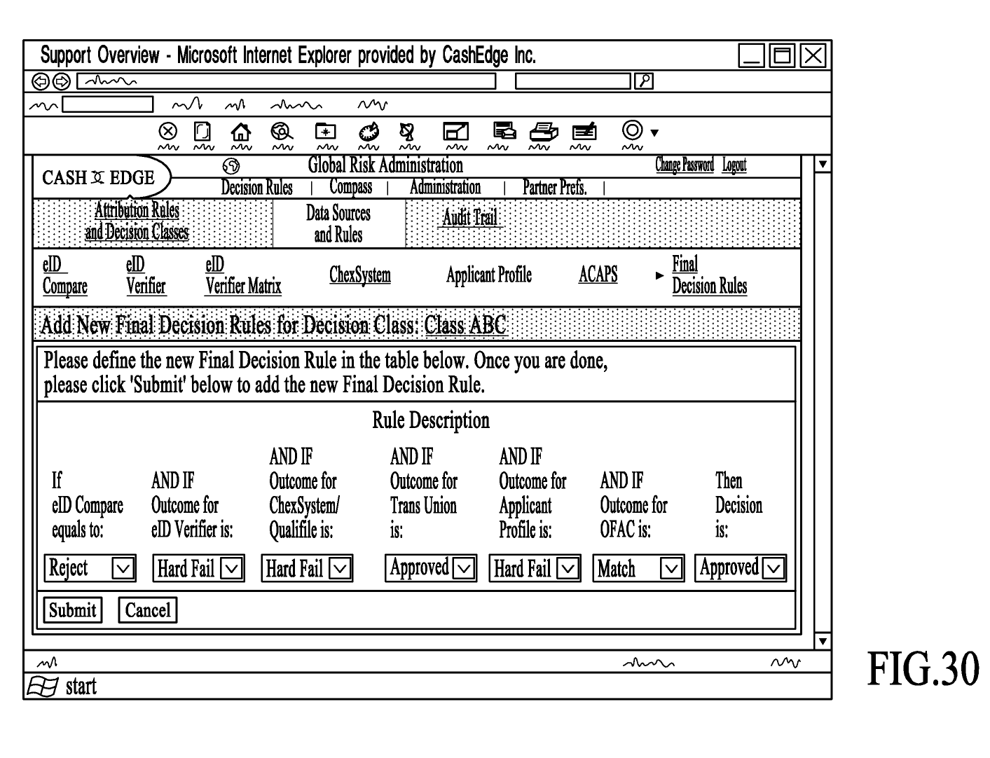

The GRA module allows the user to add, edit, delete or view the Final Decision Rules at any time. FIG. 30 is a UI screen for adding a final decision rule.

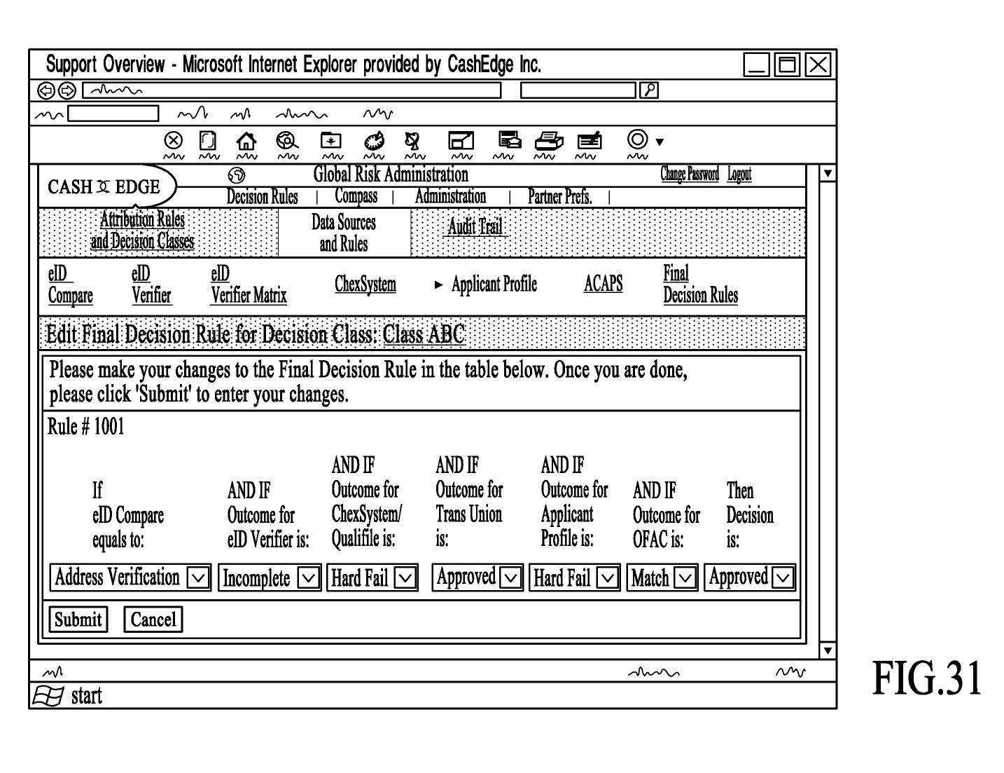

FIG. 31 is a UI screen for editing a final decision rule.

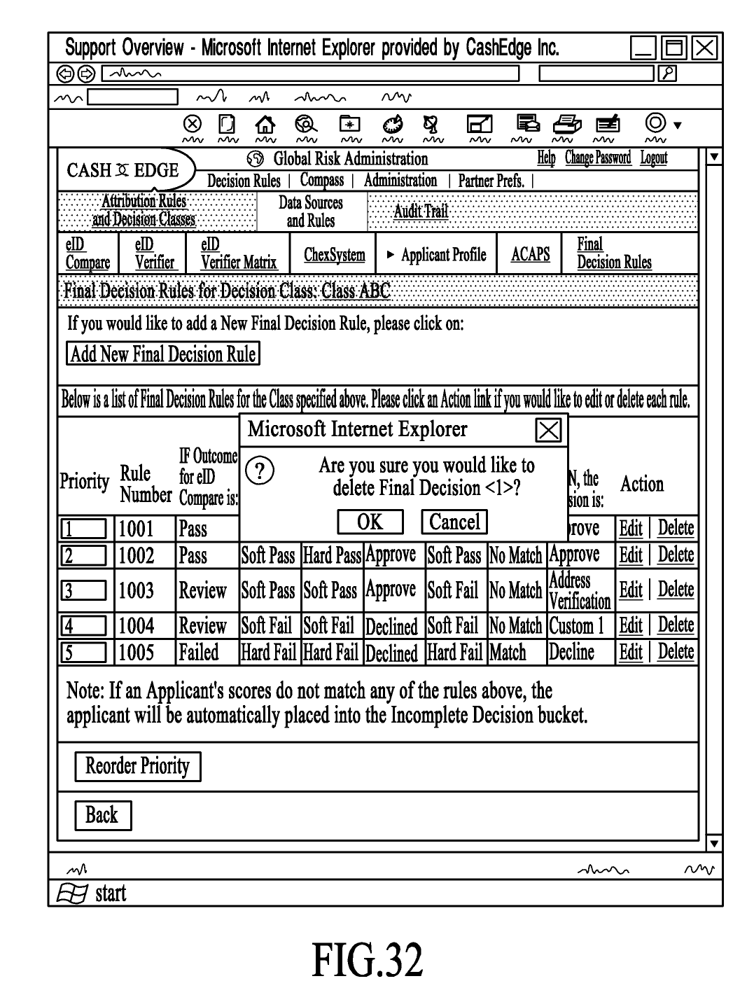

FIG. 32 is a UI screen for deleting a final decision rule.

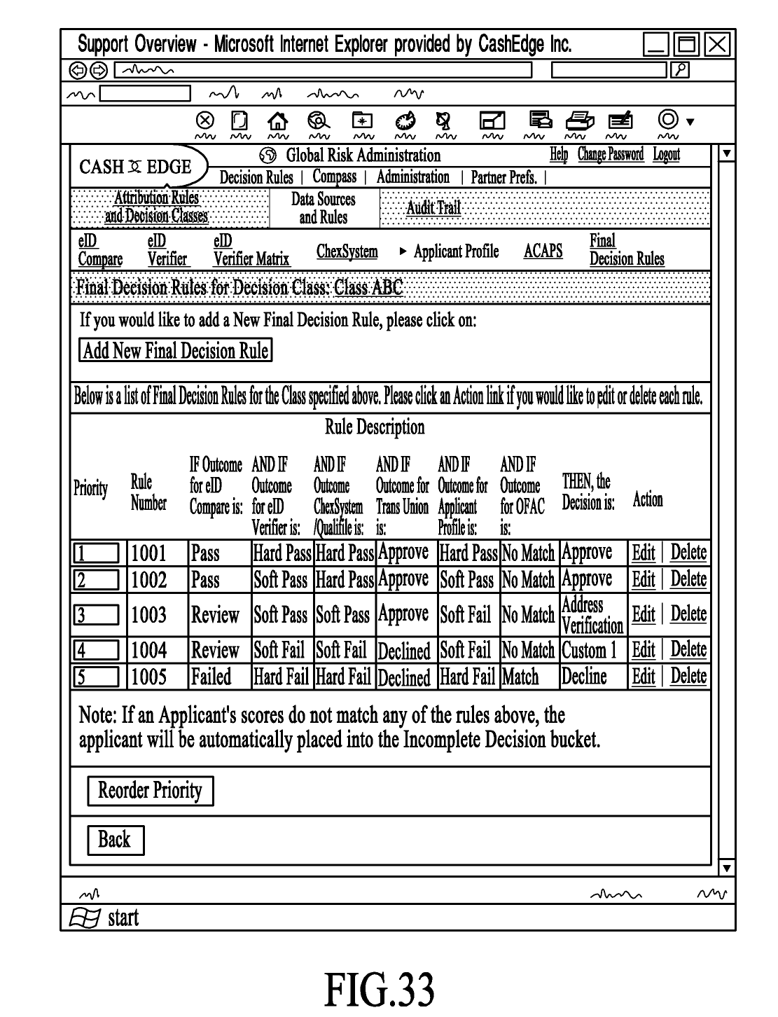

FIG. 33 is a UI screen for viewing all final decision rules that have been created.

Audit Trail

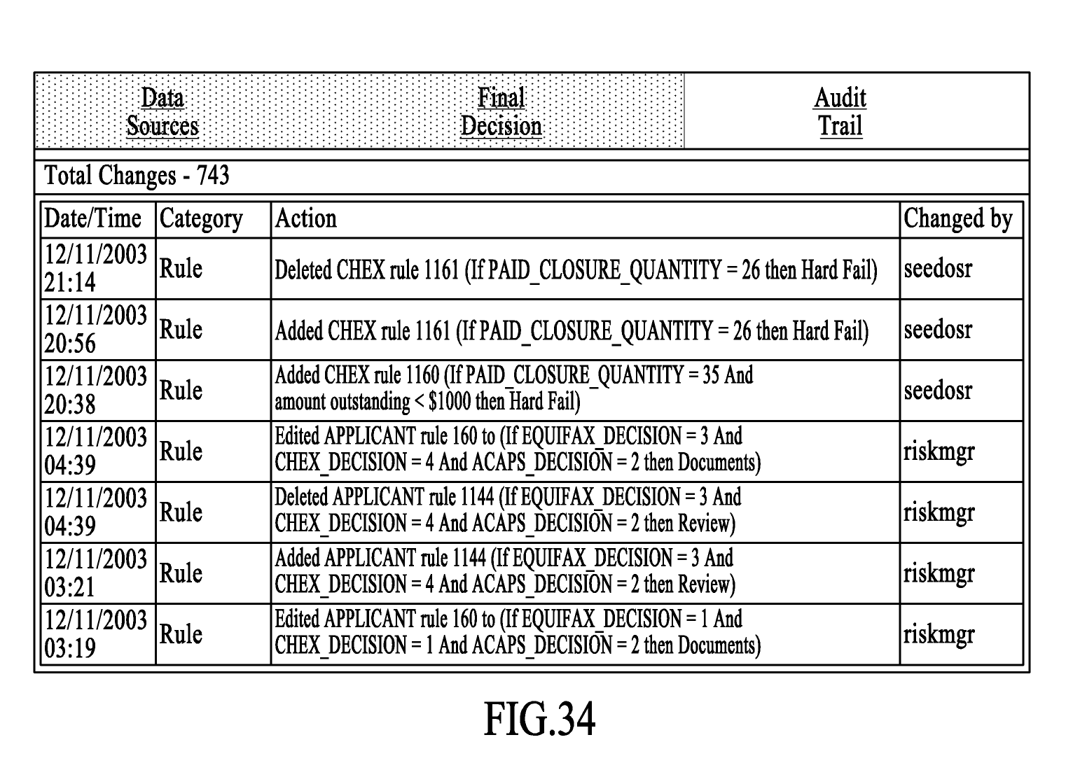

In an embodiment, the GRA module keeps an Audit Trail, or a running list of all changes made to the decision rules, under the ‘Audit Trail’ section of the GRA tool. The date timestamp, category, actual change, and the name of the user making the change are all recorded for tracking purposes. FIG. 34 is a UI screen for viewing an audit trail according to an embodiment.

Embodiment of a global risk administration (GRA) method and system as described and claimed herein include a method for assessing risk in approving applications for financial accounts, the method comprising: a user accessing a financial management system (FMS) user interface (UI) to configure a global risk administration (GRA) module, wherein the user comprises a financial institution (FI); the user assigning attribution rules using the UI, wherein attribution rules comprise characteristics of applicants for financial accounts; the user creating one or more decision classes using the UI, wherein one or more attribution rules place an applicant in a decision class; and the user creating business rules, wherein a business rule determines a manner in which the GRA module interprets data from a plurality of data sources.

An embodiment further comprises the user creating one or more business rules for each decision class.

In an embodiment, the attribution rules comprise: an applicant type comprising primary, secondary and individual; a product selected by the applicant; a promotion code used by the applicant; a manner of origination of an application, comprising an online application filled out by a customer, an application entered at a kiosk by a customer, and an application manually entered by a customer service representative; whether an applicant is a current customer; and an applicant profile, comprising information submitted by the applicant.

In an embodiment, the applicant profile information is submitted by the applicant, wherein submitting comprises: using a front-end UI supplied by the FMS; using a server-to-server message; using an XML message form; and a customer service representative manually entering information received at a call center.

An embodiment further comprises the FMS communicating directly with a plurality of data sources to collect the data on behalf of the FI.

In an embodiment, the user chooses the data sources to be used.

In an embodiment, the user prioritizes the attribution rules such that if an applicant meets requirements of more than one rule, the higher priority rule governs a decision class in which to place the applicant.

In an embodiment, the data sources comprise existing commercially available data sources that provide raw data in particular formats, and wherein the method further comprises the GRA module converting the raw data into a data source outcome using the business rules associated with a class.

An embodiment further comprises the user creating final decision rules for generating a final decision whether to approve an applicant's application for a financial account.

In an embodiment, a final decision rule uses data source outcomes to generate the final decision.

In an embodiment, the GRA module maintains an audit trail for tracking changes made to the GRA module configuration.

Embodiment of a (GRA) method and system further include a GRA method comprising: a management system (MS) providing access for multiple institutions to a single GRA module, wherein the GRA module is configurable by each institution to assess a risk of approving an application for a financial account; an institution accessing the GRA module via a user interface to configure the GRA module, wherein configuring comprises creating rules to be applied by the GRA module for assessing the risk; the MS accessing a plurality of data sources on behalf of the institution to gather raw data relevant to an applicant submitting the application; the GRA module converting the raw data to a data source outcome for each data source; and the GRA module using the data source outcomes to generate a final decision whether to approve the application.

In an embodiment, configuring further comprises creating attribution rules that characterize applicants.

In an embodiment, configuring further comprises creating decision classes that are pointed to by attribution rules.

In an embodiment, configuring further comprises creating final decision rules for generating the final decision.

In an embodiment, a final decision rule uses data source outcomes to generate the final decision.

In an embodiment, converting the raw data comprises using the attribution rules, the decision classes, business rules, and final decision rules.

An embodiment further comprises maintaining an audit trail for tracking changes made to the GRA module configuration.

Embodiment of a (GRA) method and system further include a financial management system (FMS), comprising: a plurality of databases for storing financial data, wherein financial data comprises customer data regarding individuals and companies, and financial institution data regarding financial institutions (FIs); a plurality of service modules for providing a plurality of financial services to individuals, companies and FIs; and a global risk administration (GRA) module for providing GRA services to FIs, wherein GRA services facilitate assessing a risk of approving a customer application for a financial account submitted by a customer to an FI, wherein the GRA module is configurable to, receive input from an FI to configure the GRA to evaluate data from a plurality of data sources for generating a data source outcome for each data source; and receive input from the FI to configure the GRA to generate a final decision on whether to approve an application.

In an embodiment, the FMS is further configurable to: receive application data on behalf of an FI, wherein the application data relates to a customer applying for a financial account; access the plurality of data sources; evaluate the application data in view if the plurality of data sources; and automatically generate a decision whether to approve the application.

Embodiment of a (GRA) method and system further include a computer readable medium having instruction stored thereon, that when executed in a system, cause a GRA method to be executed, the method comprising: a management system (MS) providing access for multiple institutions to a single GRA module, wherein the GRA module is configurable by each institution to assess a risk of approving an application for a financial account; an institution accessing the GRA module via a user interface to configure the GRA module, wherein configuring comprises creating rules to be applied by the GRA module for assessing the risk; the MS accessing a plurality of data sources on behalf of the institution to gather raw data relevant to an applicant submitting the application; the GRA module converting the raw data to a data source outcome for each data source; and the GRA module using the data source outcomes to generate a final decision whether to approve the application.

In an embodiment, configuring further comprises creating attribution rules that characterize applicants.

In an embodiment, configuring further comprises creating decision classes that are pointed to by attribution rules.

In an embodiment, configuring further comprises creating final decision rules for generating the final decision.

In an embodiment, a final decision rule uses data source outcomes to generate the final decision.

In an embodiment, converting the raw data comprises using the attribution rules, the decision classes, business rules, and final decision rules.

In an embodiment, the method further comprises maintaining an audit trail for tracking changes made to the GRA module configuration.

Aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word, any of the items in the list, all of the items in the list, and any combination of the items in the list.

The above description of illustrated embodiments of the method and system is not intended to be exhaustive or to limit the invention to the precise forms disclosed. While specific embodiments of, and examples for, the method and system are described herein for illustrative purposes, various equivalent modifications are possible within the scope of the invention, as those skilled in the relevant art will recognize. The teachings of the disclosure provided herein can be applied to other systems, not only for systems including graphics processing or video processing, as described above. The various operations described may be performed in a very wide variety of architectures and distributed differently than described. In addition, though many configurations are described herein, none are intended to be limiting or exclusive.

In general, in the following claims, the terms used should not be construed to limit the method and system to the specific embodiments disclosed in the specification and the claims, but should be construed to include any processing systems and methods that operate under the claims. Accordingly, the method and system is not limited by the disclosure, but instead the scope of the method and system is to be determined entirely by the claims.

While certain aspects of the method and system are presented below in certain claim forms, the inventors contemplate the various aspects of the method and system in any number of claim forms. For example, while only one aspect of the method and system may be recited as embodied in computer-readable medium, other aspects may likewise be embodied in computer-readable medium. Such computer readable media may store instructions that are to be executed by a computing device (e.g., personal computer, personal digital assistant, PVR, mobile device or the like) or may be instructions (such as, for example, Verilog or a hardware description language) that when executed are designed to create a device or software application that when operated performs aspects described above. Accordingly, the inventors reserve the right to add additional claims after filing the application to pursue such additional claim forms for other aspects of the method and system.

What is claimed is:

1. A method for assessing risk in approving applications for financial accounts, the method comprising:
a user accessing a financial management system (FMS) user interface (UI) to configure a global risk administration (GRA) module, wherein the user comprises a financial institution (FI);
the user assigning attribution rules using the UI, wherein attribution rules comprise characteristics of applicants for financial accounts;
the user creating one or more decision classes using the UI, wherein one or more attribution rules place an applicant in a decision class; and
the user creating business rules, wherein a business rule determines a manner in which the GRA module interprets data from a plurality of data sources.

2. The method of claim 1, further comprising the user creating one or more business rules for each decision class.

3. The method of claim 2, wherein the attribution rules comprise:
an applicant type comprising primary, secondary and individual;
a product selected by the applicant;
a promotion code used by the applicant;
a manner of origination of an application, comprising an online application filled out by a customer, an application entered at a kiosk by a customer, and an application manually entered by a customer service representative;
whether an applicant is a current customer; and
an applicant profile, comprising information submitted by the applicant.

4. The method of claim 3, wherein the applicant profile information is submitted by the applicant, wherein submitting comprises:
using a front-end UI supplied by the FMS;
using a server-to-server message;
using an XML message form; and
a customer service representative manually entering information received at a call center.

5. The method of claim 2, further comprising the FMS communicating directly with a plurality of data sources to collect the data on behalf of the FI.

6. The method of claim 5, wherein the user chooses the data sources to be used.

7. The method of claim 3, wherein the user prioritizes the attribution rules such that if an applicant meets requirements of more than one rule, the higher priority rule governs a decision class in which to place the applicant.

8. The method of claim 6, wherein the data sources comprise existing commercially available data sources that provide raw data in particular formats, and wherein the method further comprises the GRA module converting the raw data into a data source outcome using the business rules associated with a class.

9. The method of claim 8, further comprising the user creating final decision rules for generating a final decision whether to approve an applicant's application for a financial account.

10. The method of claim 9, wherein a final decision rule uses data source outcomes to generate the final decision.

11. The method of claim 1, wherein the GRA module maintains an audit trail for tracking changes made to the GRA module configuration.

12. A global risk administration (GRA) method comprising:
a management system (MS) providing access for multiple institutions to a single GRA module, wherein the GRA module is configurable by each institution to assess a risk of approving an application for a financial account;
an institution accessing the GRA module via a user interface to configure the GRA module, wherein configuring comprises creating rules to be applied by the GRA module for assessing the risk;
the MS accessing a plurality of data sources on behalf of the institution to gather raw data relevant to an applicant submitting the application;
the GRA module converting the raw data to a data source outcome for each data source; and
the GRA module using the data source outcomes to generate a final decision whether to approve the application.

13. The method of claim 12, wherein configuring further comprises creating attribution rules that characterize applicants.

14. The method of claim 13, wherein configuring further comprises creating decision classes that are pointed to by attribution rules.

15. The method of claim 12, wherein configuring further comprises creating final decision rules for generating the final decision.

16. The method of claim 15, wherein a final decision rule uses data source outcomes to generate the final decision.

17. The method of claim 12, wherein converting the raw data comprises using the attribution rules, the decision classes, business rules, and final decision rules.

18. The method of claim 12, further comprising maintaining an audit trail for tracking changes made to the GRA module configuration.

19. A financial management system (FMS), comprising:
a plurality of databases for storing financial data, wherein financial data comprises customer data regarding individuals and companies, and financial institution data regarding financial institutions (FIs);
a plurality of service modules for providing a plurality of financial services to individuals, companies and FIs; and
a global risk administration (GRA) module for providing GRA services to FIs, wherein GRA services facilitate assessing a risk of approving a customer application for a financial account submitted by a customer to an FI, wherein the GRA module is configurable to,
receive input from an FI to configure the GRA to evaluate data from a plurality of data sources for generating a data source outcome for each data source; and
receive input from the FI to configure the GRA to generate a final decision on whether to approve an application.

20. The financial management system of claim 19, further configurable to:
receive application data on behalf of an FI, wherein the application data relates to a customer applying for a financial account;
access the plurality of data sources;
evaluate the application data in view if the plurality of data sources; and
automatically generate a decision whether to approve the application.

21. A computer readable medium having instruction stored thereon, that when executed in a system, cause a global risk administration (GRA) method to be executed, the method comprising:
a management system (MS) providing access for multiple institutions to a single GRA module, wherein the GRA module is configurable by each institution to assess a risk of approving an application for a financial account;
an institution accessing the GRA module via a user interface to configure the GRA module, wherein configuring comprises creating rules to be applied by the GRA module for assessing the risk;
the MS accessing a plurality of data sources on behalf of the institution to gather raw data relevant to an applicant submitting the application;
the GRA module converting the raw data to a data source outcome for each data source; and
the GRA module using the data source outcomes to generate a final decision whether to approve the application.

22. The computer readable medium of claim 21, wherein configuring further comprises creating attribution rules that characterize applicants.

23. The computer readable medium of claim 22, wherein configuring further comprises creating decision classes that are pointed to by attribution rules.

24. The computer readable medium of claim 21, wherein configuring further comprises creating final decision rules for generating the final decision.

25. The computer readable medium of claim 24, wherein a final decision rule uses data source outcomes to generate the final decision.

26. The computer readable medium of claim 21, wherein converting the raw data comprises using the attribution rules, the decision classes, business rules, and final decision rules.

27. The computer readable medium of claim 21, wherein the method further comprises maintaining an audit trail for tracking changes made to the GRA module configuration.
